(19) United States
(12) Patent Application Publication
(10) Pub. No.: US 2020/0366049 A1
(43) Pub. Date: Nov. 19, 2020

(54) LASER GAS MANAGEMENT SYSTEM, METHOD FOR MANUFACTURING ELECTRONIC DEVICE, AND METHOD FOR CONTROLLING EXCIMER LASER SYSTEM

(71) Applicant: Gigaphoton Inc., Tochigi (JP)

(72) Inventors: Hiroaki TSUSHIMA, Oyama-shi (JP); Natsushi SUZUKI, Oyama-shi (JP); Osamu WAKABAYASHI, Oyama-shi (JP)

(73) Assignee: Gigaphoton Inc., Tochigi (JP)

(21) Appl. No.: 16/987,716

(22) Filed: Aug. 7, 2020

Related U.S. Application Data
(63) Continuation of application No. PCT/JP2018/012162, filed on Mar. 26, 2018.

(51) Int. Cl. H01S 3/134; H01S 3/097

(52) U.S. Cl. CPC H01S 3/134; H01S 3/097

(57) ABSTRACT

A laser gas management system includes a gas regeneration apparatus connected to a plurality of excimer laser apparatuses and configured to regenerate a laser gas discharged from the plurality of excimer laser apparatuses into a regenerated gas and supply the plurality of excimer laser apparatuses with the regenerated gas and a controller configured to evaluate whether or not at least one parameter of any of the plurality of excimer laser apparatuses has exceeded a range determined in advance and determine that abnormality has occurred in the gas regeneration apparatus when the at least one parameter has exceeded the range determined in advance in two or more of the excimer laser apparatuses.

### CROSS-REFERENCE TO RELATED APPLICATIONS

The present application is a continuation application of International Application No. PCT/JP2018/012162, filed on Mar. 26, 2018, the entire contents of which are hereby incorporated by reference.

### BACKGROUND

### 1. Technical Field

The present disclosure relates to a laser gas management system, a method for manufacturing an electronic device, and a method for controlling an excimer laser system.

### 2. Related Art

In recent years, a semiconductor exposure apparatus (hereinafter referred to as “exposure apparatus”) is required to improve the resolution thereof as a semiconductor integrated circuit is increasingly miniaturized and highly integrated. To this end, reduction in the wavelength of the light emitted from a light source for exposure is underway. A gas laser apparatus is typically used as the light source for exposure in place of a mercury lamp in related art. For example, a KrF excimer laser apparatus, which is configured to output ultraviolet laser light having a wavelength of 248 nm, and an ArF excimer laser apparatus, which is configured to output ultraviolet laser light having a wavelength of 193 nm, are used as the gas laser apparatus for exposure.

As a next-generation exposure technology, liquid-immersion exposure, in which the gap between the exposure lens of the exposure apparatus and a wafer is filled with a liquid, has been put into use. In the liquid-immersion exposure, since the refractive index of the gap between the exposure lens and the wafer changes, the apparent wavelength of the light from the light source for exposure is shortened. In the liquid-immersion exposure using an ArF excimer laser apparatus as the light source for exposure, the wafer is irradiated with ultraviolet light having an in-water wavelength of 134 nm. The technology described above is called ArF liquid-immersion exposure (or ArF liquid-immersion lithography).

KrF and ArF excimer laser apparatuses each have a wide spontaneous oscillation range from about 350 to 400 pm. The chromatic aberrations therefore occur in some cases when the projection lens is made of a material that transmits ultraviolet light, such as the KrF laser light and ArF laser light. As a result, the resolution could decrease. To avoid the decrease in the resolution, the spectral linewidth of the laser light outputted from the gas laser apparatus needs to be narrow enough to make the chromatic aberrations negligible. A line narrowing module (LNM) including a line narrowing element (such as etalon and grating) is therefore provided in some cases in the laser resonator of the gas laser apparatus to narrow the spectral linewidth. A laser apparatus having a narrowed spectral linewidth is hereinafter referred to as a narrowed-linewidth laser apparatus.

### CITATION LIST

### Patent Literature

[PTL 1] JP-A-03-265180
[PTL 2] JP-A-2001-044534
[PTL 3] WO 2017/081819
[PTL 4] WO 2017/072863
[PTL 5] WO 2015/076415

### SUMMARY

A laser gas management system according to a viewpoint of the present disclosure includes a gas regeneration apparatus connected to a plurality of excimer laser apparatuses and configured to regenerate a laser gas discharged from the plurality of excimer laser apparatuses into a regenerated gas and supply the plurality of excimer laser apparatuses with the regenerated gas and a controller configured to evaluate whether or not at least one parameter of any of the plurality of excimer laser apparatuses has exceeded a range determined in advance and determine that abnormality has occurred in the gas regeneration apparatus when the at least one parameter has exceeded the range determined in advance in two or more of the excimer laser apparatuses.

A laser gas management system according to another viewpoint of the present disclosure includes a gas regeneration apparatus connected to a plurality of excimer laser apparatuses and configured to regenerate a laser gas discharged from the plurality of excimer laser apparatuses into a regenerated gas and supply the plurality of excimer laser apparatuses with the regenerated gas and a controller configured to evaluate whether or not at least one parameter of any of the plurality of excimer laser apparatuses has exceeded a range determined in advance and determine that abnormality has occurred in the gas regeneration apparatus when the at least one parameter has exceeded the range determined in advance in a predetermined number of excimer laser apparatuses out of the excimer laser apparatuses, the predetermined number being at least two.

A method for manufacturing an electronic device according to another viewpoint of the present disclosure includes causing an excimer laser apparatus in an excimer laser system to generate laser light, the excimer laser system including a plurality of excimer laser apparatuses, a gas regeneration apparatus connected to the plurality of excimer laser apparatuses and configured to regenerate a laser gas discharged from the plurality of excimer laser apparatuses into a regenerated gas and supply the plurality of excimer laser apparatuses with the regenerated gas, and a controller configured to evaluate whether or not at least one parameter of any of the plurality of excimer laser apparatuses has exceeded a range determined in advance and determine that abnormality has occurred in the gas regeneration apparatus when the at least one parameter has exceeded the range determined in advance in a predetermined number of excimer laser apparatuses out of the excimer laser apparatuses, the predetermined number being at least two; outputting the laser light to an exposure apparatus; and exposing a light sensitive substrate with the laser light in the exposure apparatus to manufacture the electronic device.

A method for controlling an excimer laser system according to another viewpoint of the present disclosure is a method for controlling an excimer laser system including a plurality of excimer laser apparatuses and a gas regeneration apparatus configured to regenerate a laser gas discharged from the plurality of excimer laser apparatuses into a regenerated gas and supply the plurality of excimer laser apparatuses with the regenerated gas, the method including evaluating whether or not at least one parameter of any of the plurality of excimer laser apparatuses has exceeded a range determined in advance and determining that abnormality has occurred in the gas regeneration apparatus when the at least one parameter has exceeded the range determined in advance in a predetermined number of excimer laser apparatuses out of the excimer laser apparatuses, the predetermined number being at least two.

### BRIEF DESCRIPTION OF THE DRAWINGS

Embodiments of the present disclosure will be described below only by way of example with reference to the accompanying drawings.

FIG. 1 schematically shows the configurations of a gas regeneration apparatus 50 according to Comparative Example and a plurality of laser apparatuses 301 to 30n connected thereto.

FIG. 2 schematically shows the configuration of a laser apparatus 30k shown in

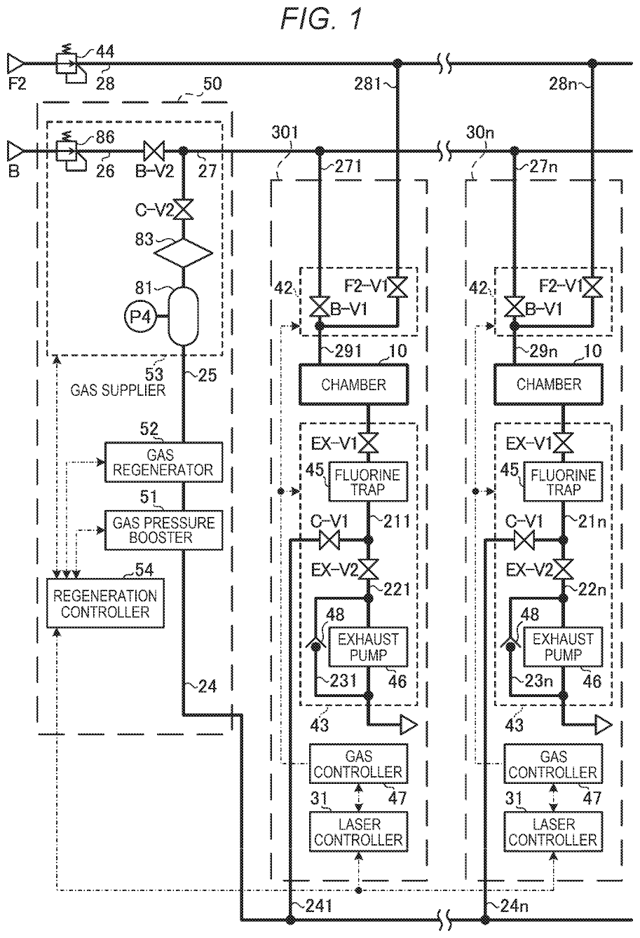

FIG. 1.

FIG. 3 schematically shows the configuration of a gas regeneration apparatus 50 shown in FIG. 1.

FIG. 4 is a flowchart showing the processes carried out by a gas pressure boost controller 541 in the gas regeneration apparatus 50 shown in FIG. 1.

FIG. 5 is a flowchart showing the processes carried out by a gas regeneration controller 542 in the gas regeneration apparatus 50 shown in FIG. 1.

FIG. 6 is a flowchart showing the processes carried out by a gas supply controller 543 in the gas regeneration apparatus 50 shown in FIG. 1.

FIG. 7 schematically shows the configurations of a laser gas management system according to a first embodiment of the present disclosure and laser apparatuses 301 to 30n connected thereto.

FIG. 8 is a flowchart in accordance with which a laser management controller 55 evaluates abnormality of the gas regeneration apparatus 50 in the first embodiment.

FIG. 9 is a flowchart showing the details of one of the processes shown in FIG. 8, the process of counting the number of laser apparatuses in which abnormality of a laser performance parameter has been detected.

FIG. 10 is a flowchart of energy control performed by a laser controller 31 of each of the laser apparatuses in the first embodiment.

FIG. 11 is a flowchart of gas control performed by the laser controller 31 of each of the laser apparatuses in the first embodiment.

FIG. 12 is a flowchart showing the details of gas pressure control shown in FIG. 11.

FIG. 13 is a flowchart showing the details of partial gas replacement shown in FIG. 11.

FIG. 14 is a flowchart in accordance with which the laser controller 31 of each of the laser apparatuses sets an abnormality flag Fk in the first embodiment.

FIG. 15 is a flowchart showing the details of the measurement and calculation of laser performance parameters shown in FIG. 14.

FIG. 16 schematically shows the configurations of a laser gas management system according to a second embodiment of the present disclosure and laser apparatuses 301 to 30n connected thereto.

FIG. 17 is a flowchart showing the details of the process in which the laser management controller 55 counts the number of laser apparatuses in which abnormality of a laser performance parameter has been detected in the second embodiment.

FIG. 18 is a flowchart in accordance with which the laser management controller 55 sets the abnormality flag Fk in the second embodiment.

FIG. 19 is a flowchart of energy control performed by the laser controller 31 of each of the laser apparatuses in the second embodiment.

FIG. 20A shows an example of gas-control-related data stored in a storage 57 of the laser management controller 55 in the second embodiment.

FIG. 20B shows an example of the gas-control-related data stored in the storage 57 of the laser management controller 55 in the second embodiment.

FIG. 21 is a flowchart in accordance with which the laser management controller 55 calculates the laser performance parameters in the second embodiment.

FIG. 22 is a flowchart showing the details of a gas-control-related data reading process at a point of time Time(a) shown in FIG. 21.

FIG. 23 is a flowchart showing the details of the gas-control-related data reading process at a point of time Time(b) shown in FIG. 21.

FIG. 24 is a flowchart showing the details of the process of calculating the laser performance parameters per predetermined number of pulses ΔN shown in FIG. 21.

FIG. 25 is a flowchart showing the details of a pulse energy stability calculation process shown in FIG. 21.

FIG. 26 is a table showing an example of evaluation of abnormality of the gas regeneration apparatus 50 based on the laser performance parameters in the second embodiment.

FIG. 27 shows graphs illustrating a change in a laser performance parameter taken into consideration for the calculation of the threshold for evaluation of abnormality of the laser performance parameter in a third embodiment of the present disclosure.

FIG. 28 is a flowchart in accordance with which the laser management controller 55 sets the abnormality flag Fk in the third embodiment.

FIG. 29 is a flowchart in accordance with which the laser management controller 55 calculates a threshold for abnormality evaluation in the third embodiment.

FIG. 30 describes the concept of burst operation performed by each of the laser apparatuses in a fourth embodiment of the present disclosure.

FIG. 31 describes a burst characteristic value analyzed in the fourth embodiment of the present disclosure.

FIG. 32 is a flowchart in accordance with which the laser management controller 55 sets the abnormality flag Fk in the fourth embodiment.

FIG. 33 is a flowchart of energy control performed by the laser controller 31 of each of the laser apparatuses in the fourth embodiment.

FIG. 34 is a flowchart in accordance with which the laser management controller 55 calculates the laser performance parameters in the fourth embodiment.

FIG. 35 is a flowchart showing the details of the process of calculating the burst characteristic value shown in FIG. 34.

FIG. 36 is a table showing an example of evaluation of abnormality of the gas regeneration apparatus 50 based on the laser performance parameters in the fourth embodiment.

FIG. 37 schematically shows the configurations of a laser gas management system according to a fifth embodiment of the present disclosure and laser apparatuses 301 to 30n connected thereto.

FIG. 38 is a flowchart in accordance with which a laser management controller 55 evaluates abnormality of the gas regeneration apparatus 50 in the fifth embodiment.

FIG. 39 is a flowchart showing the details of a process shown in FIG. 38 that is the process of causing a laser apparatus in which abnormality of a laser performance parameter has been detected to stop operating.

FIG. 40 schematically shows the configuration of an exposure apparatus 100 connected to a laser apparatus 30k.

### DETAILED DESCRIPTION

<Contents>

1. Excimer laser apparatus and gas regeneration apparatus according to Comparative Example

### 1.1 Configuration

1.1.1 Laser apparatus
1.1.1.1 Laser oscillation system
1.1.1.2 Laser gas control system
1.1.2 Gas regeneration apparatus
1.1.2.1 Gas pressure booster
1.1.2.2 Gas regenerator
1.1.2.3 Gas supplier
1.1.2.4 Gas regeneration controller

### 1.2 Operation

1.2.1 Operation of laser apparatus
1.2.1.1 Operation of laser oscillation system
1.2.1.2 Operation of laser gas control system
1.2.2 Operation of gas regeneration apparatus
1.2.2.1 Operation of gas pressure boost controller
1.2.2.2 Operation of gas regeneration controller
1.2.2.3 Operation of gas supply controller

### 1.3 Problems

2. Laser gas management system that evaluates abnormality of gas regeneration apparatus

### 2.1 Configuration

### 2.2 Operation

2.2.1 Process of evaluating abnormality of gas regeneration apparatus
2.2.1.1 Process of counting number of laser apparatuses in which abnormality has been detected
2.2.2 Processes carried out by laser controller
2.2.2.1 Energy control
2.2.2.2 Gas control
2.2.3 Process of setting abnormality flag Fk
2.2.3.1 Measurement and calculation of laser performance parameters

### 2.3 Effects

3. Case where laser management controller sets abnormality flag

### 3.1 Configuration

### 3.2 Operation

3.2.1 Process of counting number of laser apparatuses in which abnormality has been detected
3.2.2 Process of setting abnormality flag Fk
3.2.3 Processes carried out by laser controller
3.2.4 Calculation of laser performance parameters
3.2.5 Evaluation of abnormality of gas regeneration apparatus based on laser performance parameters
4. Case where threshold for abnormality evaluation is calculated in accordance with number of pulses in chamber

### 4.1 Overview

### 4.2 Operation

4.2.1 Process of setting abnormality flag Fk
4.2.1.1 Calculation of thresholds for evaluation of abnormality of laser performance parameters
5. Case where abnormality of xenon concentration is evaluated based on burst characteristic value

### 5.1 Overview

### 5.2 Operation

5.2.1 Process of setting abnormality flag Fk
5.2.2 Processes carried out by laser controller
5.2.3 Calculation of laser performance parameters
5.2.4 Evaluation of abnormality of gas regeneration apparatus based on laser performance parameters
6. Case where regenerated gas and new gas are switchable from one to the other on a laser basis

### 6.1 Configuration

### 6.2 Operation

6.2.1 Process of evaluating abnormality of gas regeneration apparatus
6.2.1.1 Process of causing laser apparatus in which abnormality has been detected to stop operating

### 7. Others

Embodiments of the present disclosure will be described below in detail with reference to the drawings. The embodiments described below each show an example of the present disclosure and are not intended to limit the contents of the present disclosure. Further, all configurations and operations described in the embodiments are not necessarily essential as configurations and operations in the present disclosure. The same component has the same reference character, and no redundant description of the same component will be made.

### 1. Excimer Laser Apparatus and Gas Regeneration Apparatus According to Comparative Example

### 1.1 Configuration

FIG. 1 schematically shows the configurations of a gas regeneration apparatus 50 according to Comparative Example and a plurality of laser apparatuses 301 to 30n connected thereto.

The plurality of laser apparatuses 301 to 30n include n laser apparatuses. It is, however, noted that FIG. 1 shows only the numbered−1 laser apparatus 301 and the numbered-n laser apparatus 30n. The laser apparatuses 301 to 30n have substantially the same configuration. In the present disclosure, the numbered-k laser apparatus is referred to as the laser apparatus 30k in some cases, where k is an arbitrary integer greater than or equal to 1 but smaller than or equal to n. The components provided in the numbered-k laser apparatus 30k are each also expressed by a reference character having the suffix k.

The laser apparatuses 301 to 30n are connected to a pipe 24 via pipes 241 to 24n, respectively. The pipe 24 is connected to the gas regeneration apparatus 50. The pipe 24 is configured to supply the gas regeneration apparatus 50 with a discharge gas discharged from each of the laser apparatuses 301 to 30n.

The laser apparatuses 301 to 30n are connected to a pipe 27 via pipes 271 to 27n, respectively. The pipe 27 is connected to the gas regeneration apparatus 50. The pipe 27 and the pipes 271 to 27n are configured to supply the laser apparatuses 301 to 30n with a buffer gas supplied from the gas regeneration apparatus 50. When the laser apparatuses 301 to 30n are each an ArF excimer laser apparatus, the buffer gas is a laser gas containing, for example, an argon gas, a neon gas, and a small amount of xenon gas. The buffer gas may be a new gas supplied from a buffer gas supply source B, which will be described later, or may be a regenerated gas having impurities reduced in the gas regeneration apparatus 50.

When the laser apparatuses 301 to 30n are each a KrF excimer laser apparatus, the buffer gas is a laser gas containing, for example, a krypton gas and a neon gas.

When the laser apparatuses 301 to 30n are each an XeF excimer laser apparatus, the buffer gas is a laser gas containing, for example, a xenon gas and a neon gas.

The laser apparatuses 301 to 30n are connected to a pipe 28 via pipes 281 to 28n, respectively. The pipe 28 is connected to a fluorine-containing gas supply source F2. The fluorine-containing gas supply source F2 is a gas cylinder containing a fluorine-containing gas. When the laser apparatuses 301 to 30n are each an ArF excimer laser apparatus, the fluorine-containing gas is a laser gas that is, for example, a mixture of a fluorine gas, an argon gas, and a neon gas. The pressure at which the fluorine-containing gas is supplied from the fluorine-containing gas supply source F2 to the pipe 28 is set by a regulator 44. The regulator 44 is configured to set the pressure at which the fluorine-containing gas is supplied at a value, for example, greater than or equal to 5,000 hPa but smaller than or equal to 6,000 hPa. The pipe 28 and the pipes 281 to 28n are configured to supply the laser apparatuses 301 to 30n with the fluorine-containing gas supplied from the fluorine-containing gas supply source F2.

When the laser apparatuses 301 to 30n are each a KrF excimer laser apparatus, the fluorine-containing gas is a laser gas containing, for example, a fluorine gas, a krypton gas, and a neon gas.

When the laser apparatuses 301 to 30n are each an XeF excimer laser apparatus, the fluorine-containing gas is a laser gas containing, for example, a fluorine gas, a xenon gas, and a neon gas.

1.1.1 Laser Apparatus

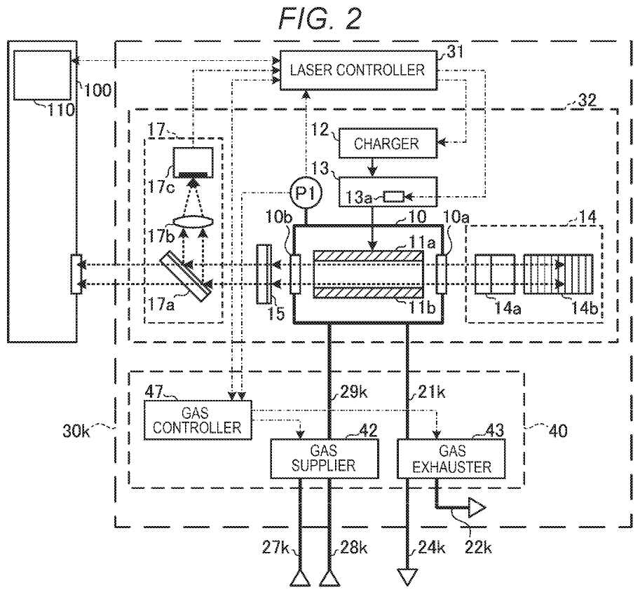

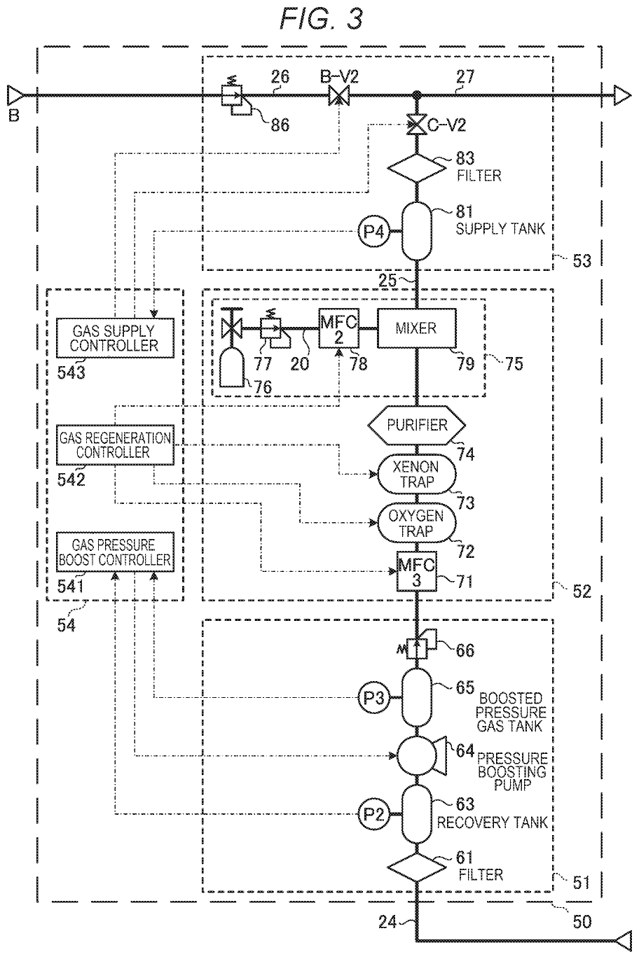

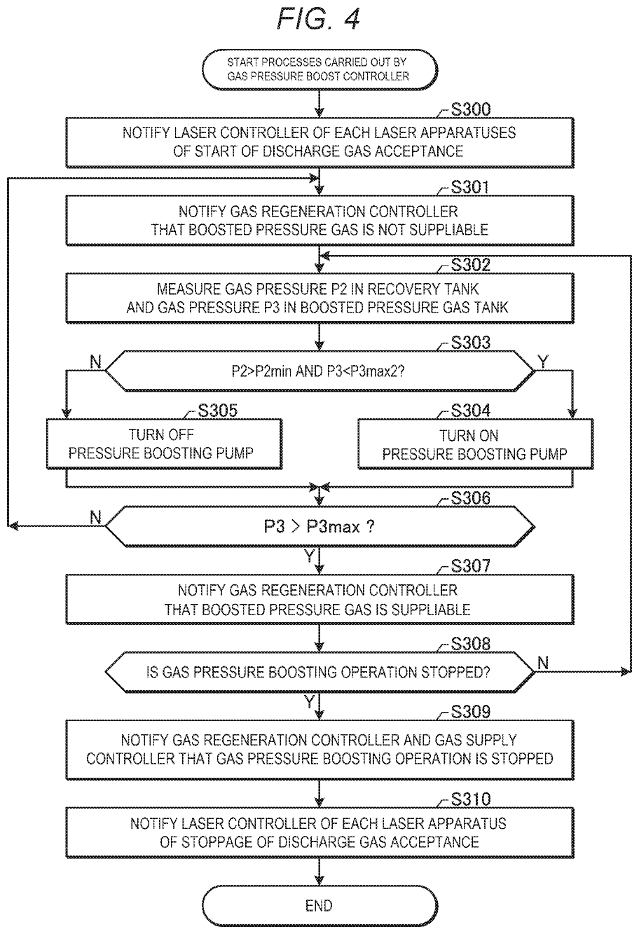

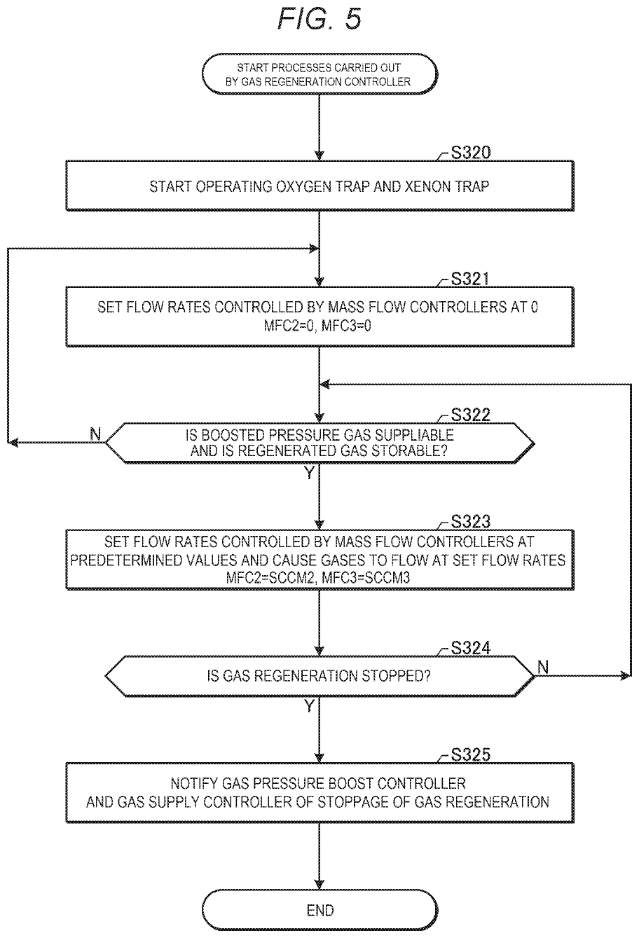

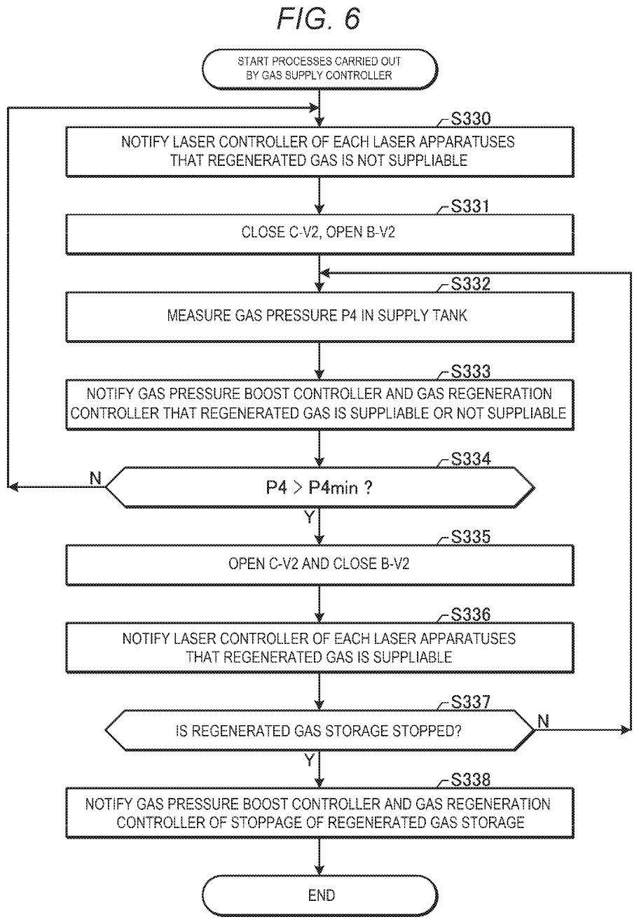

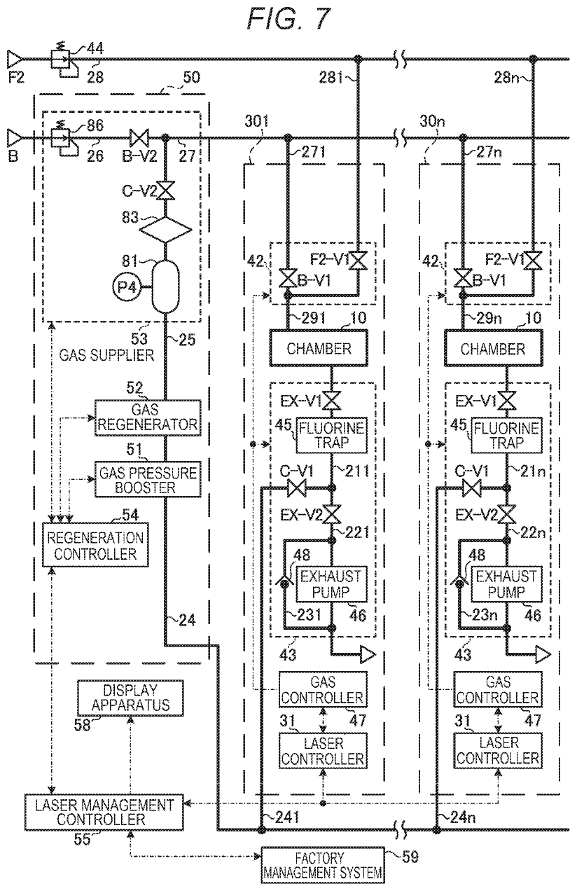

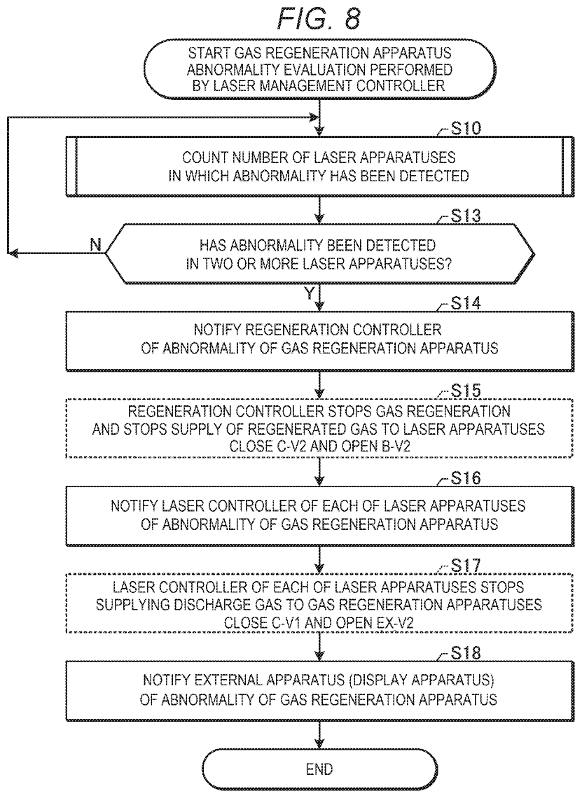

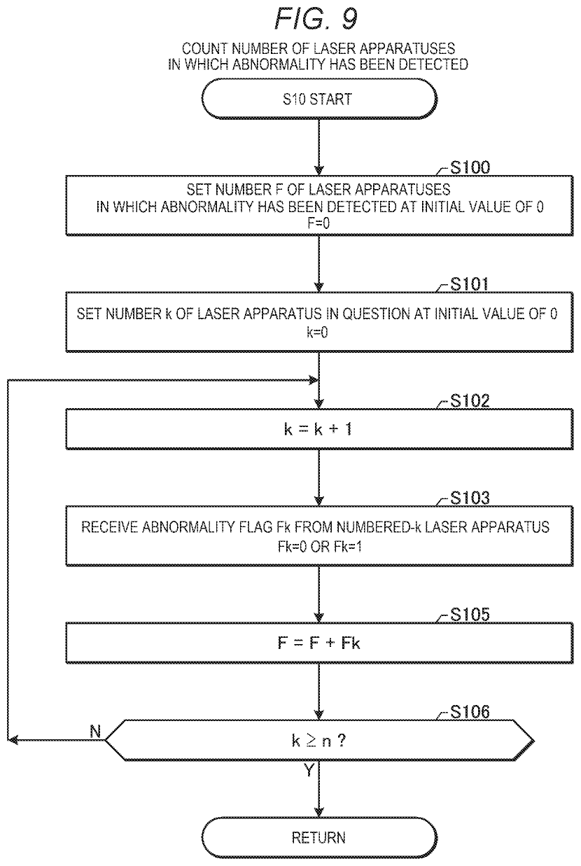

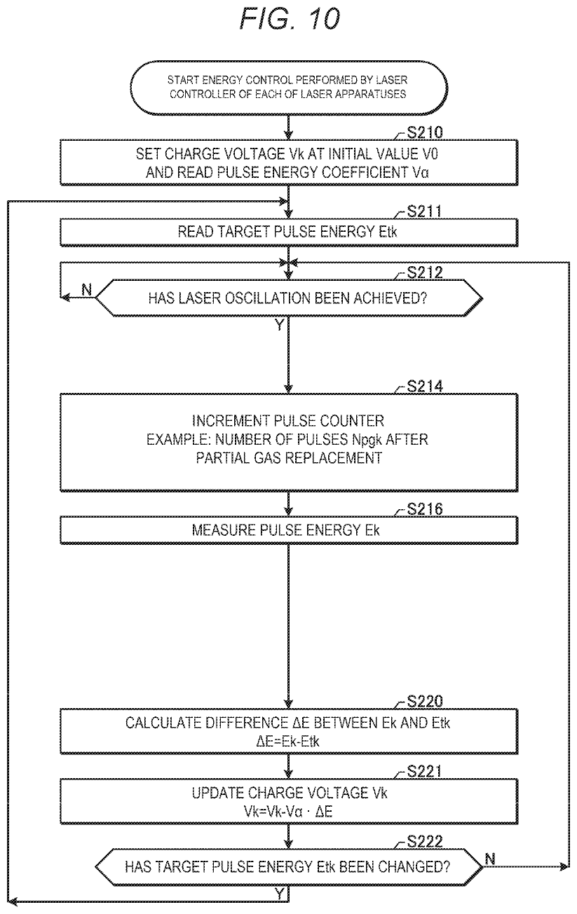

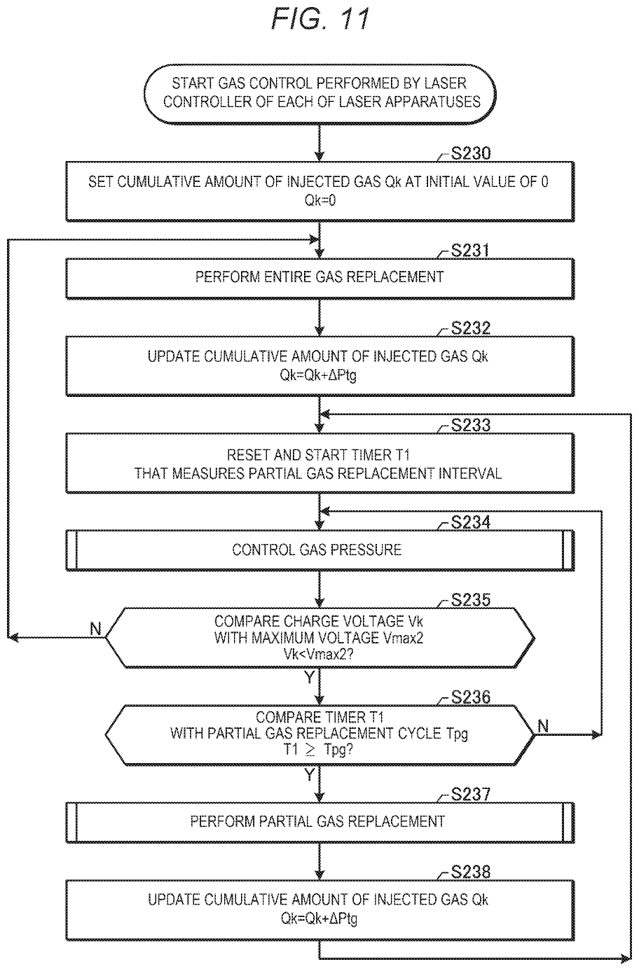

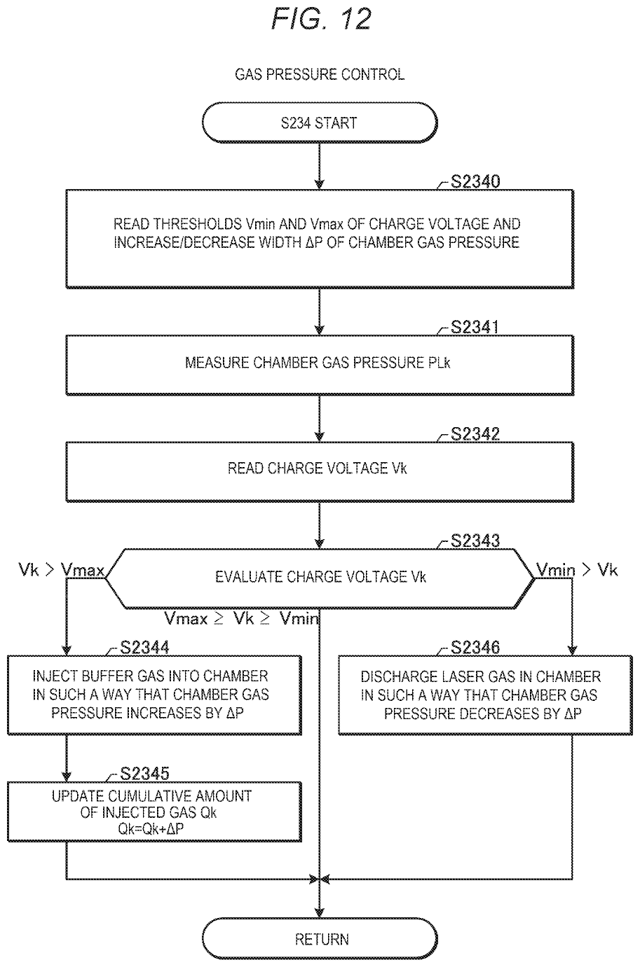

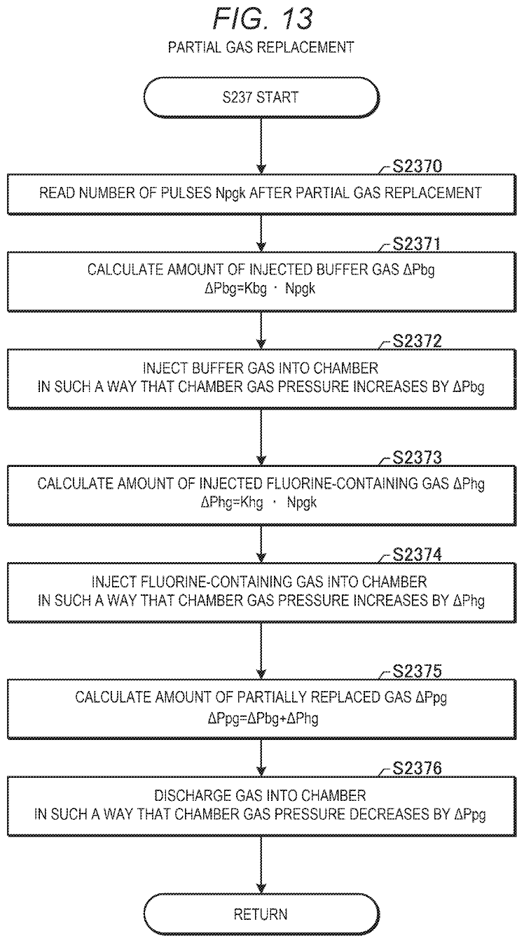

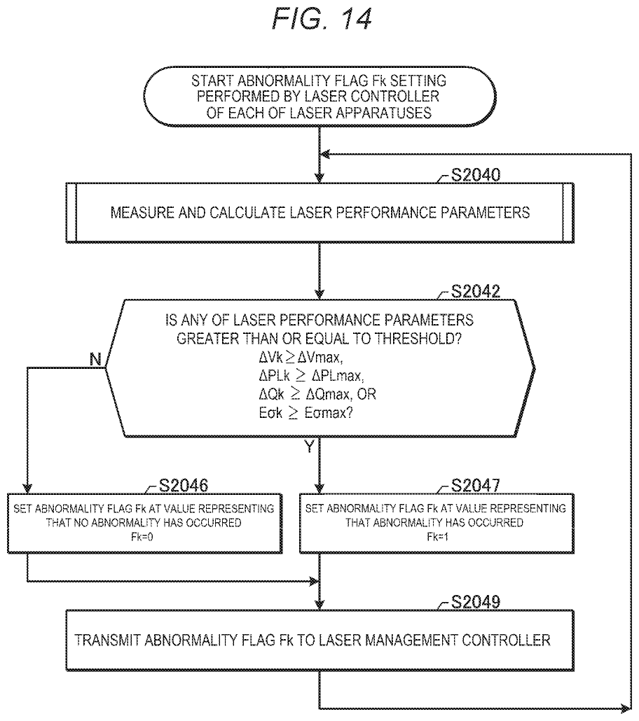

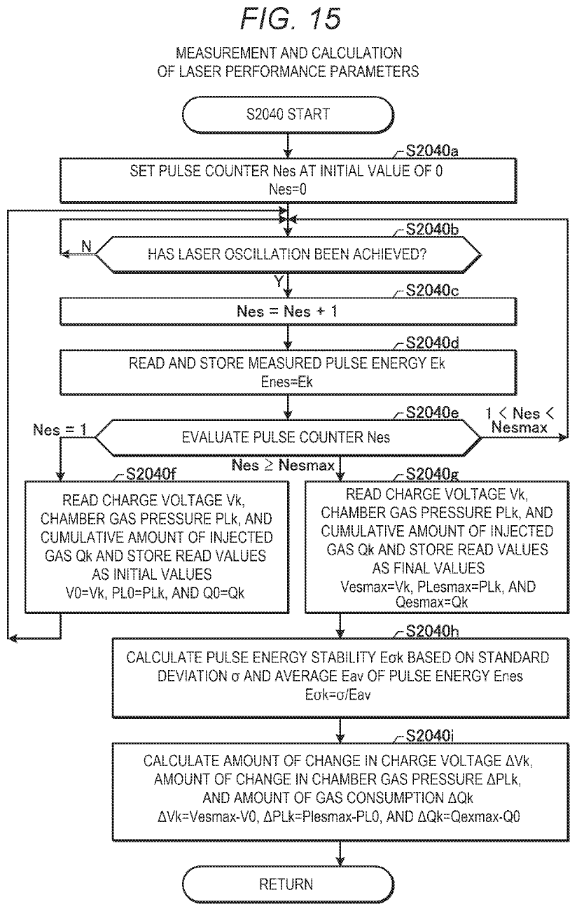

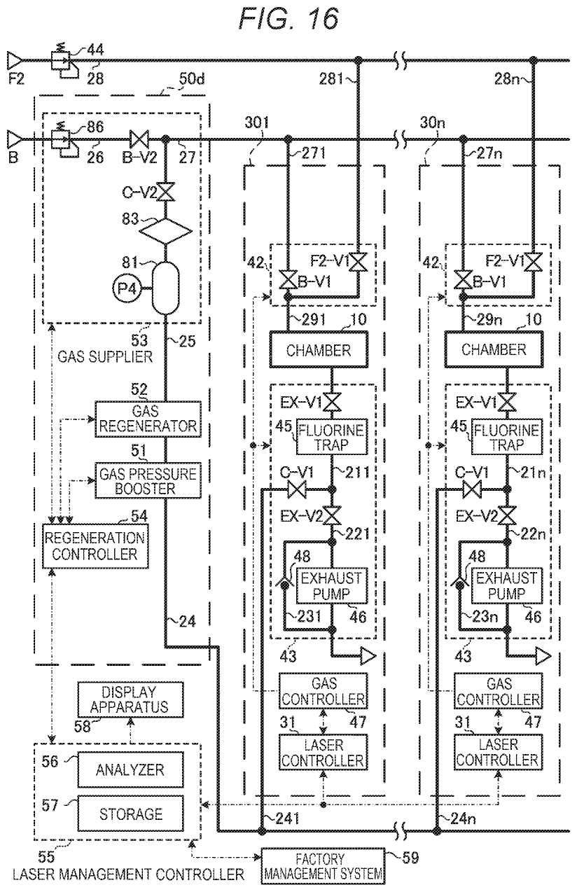

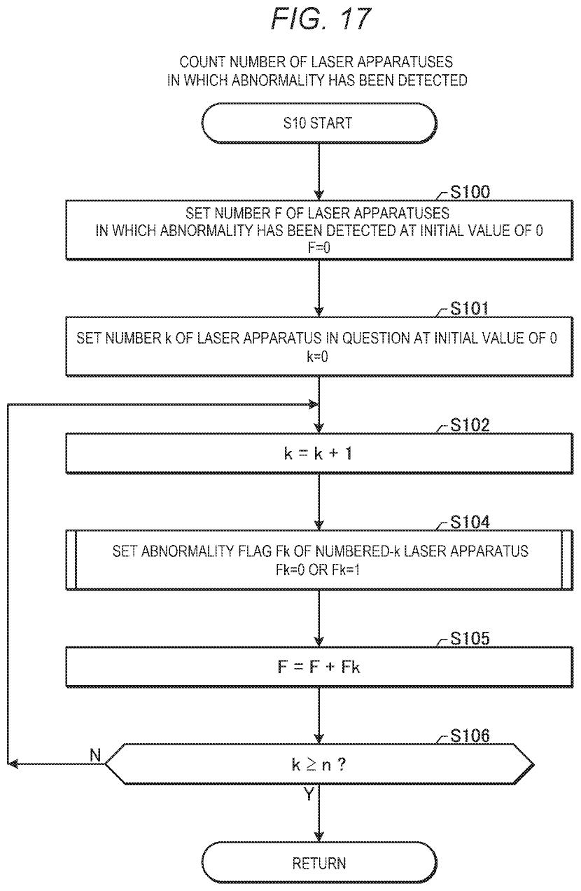

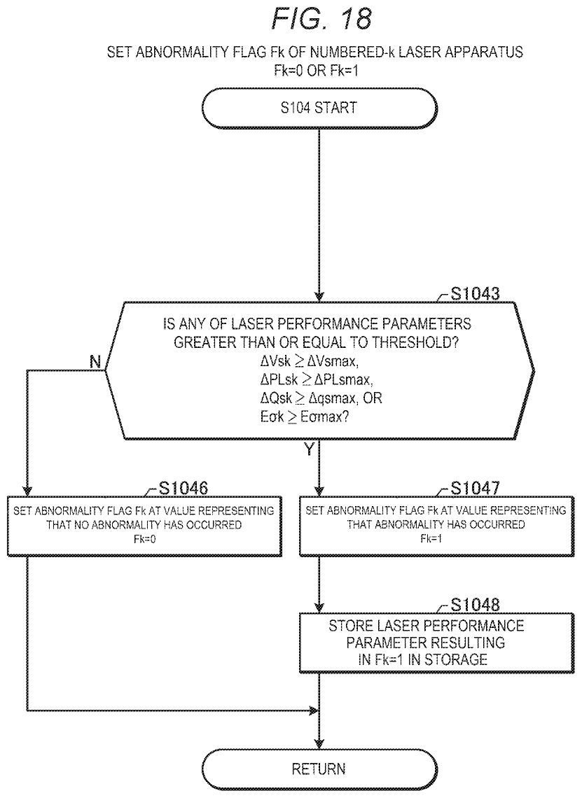

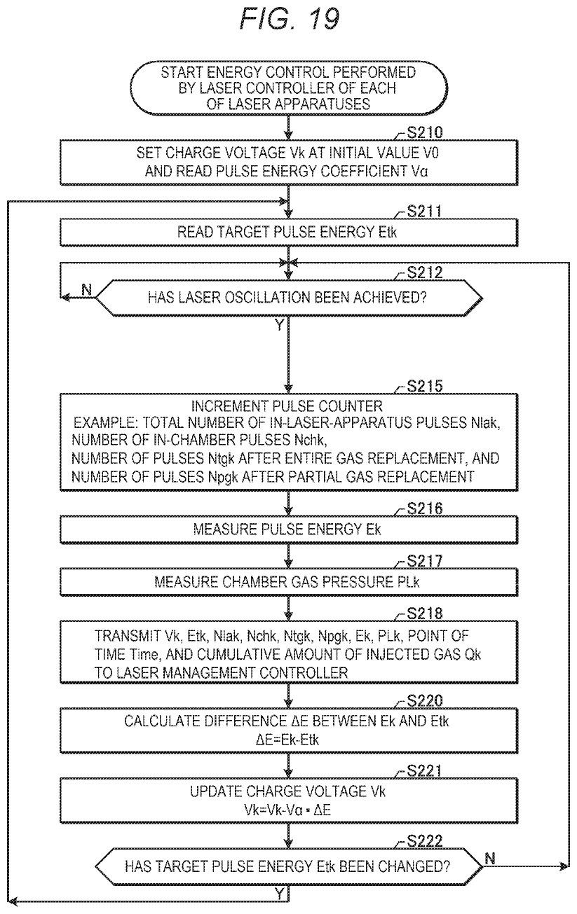

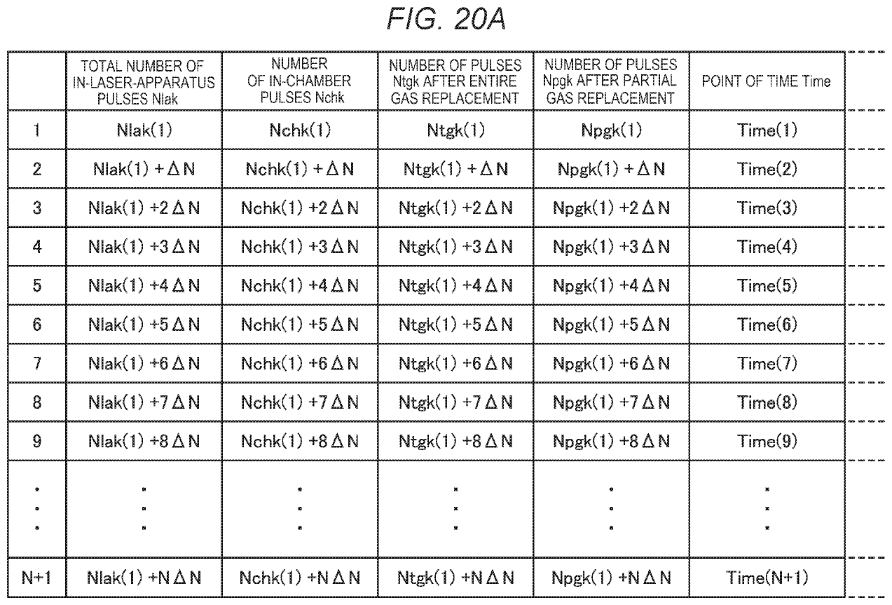

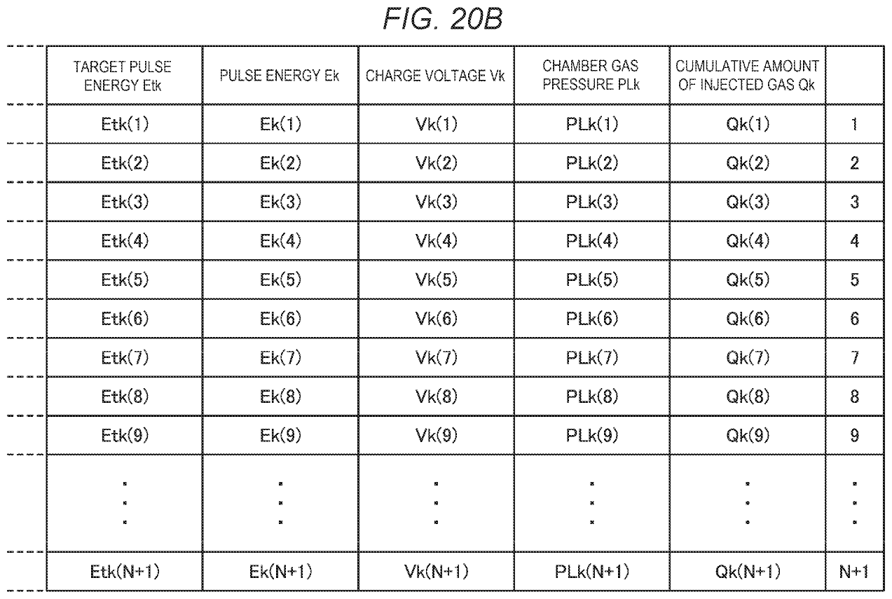

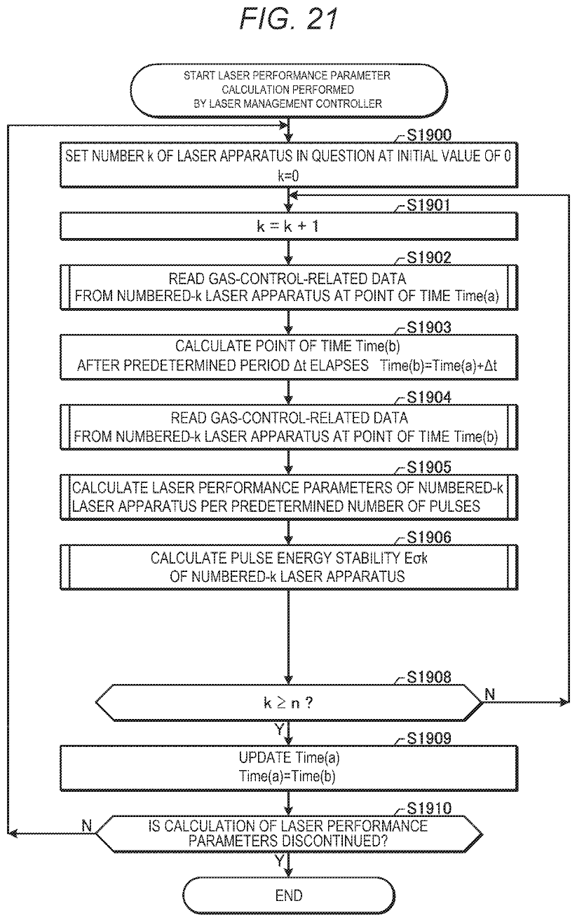

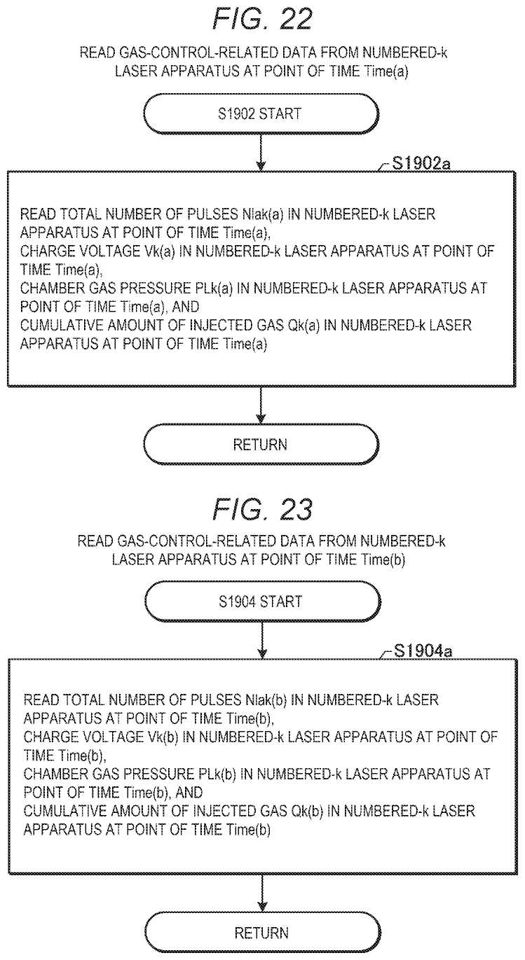

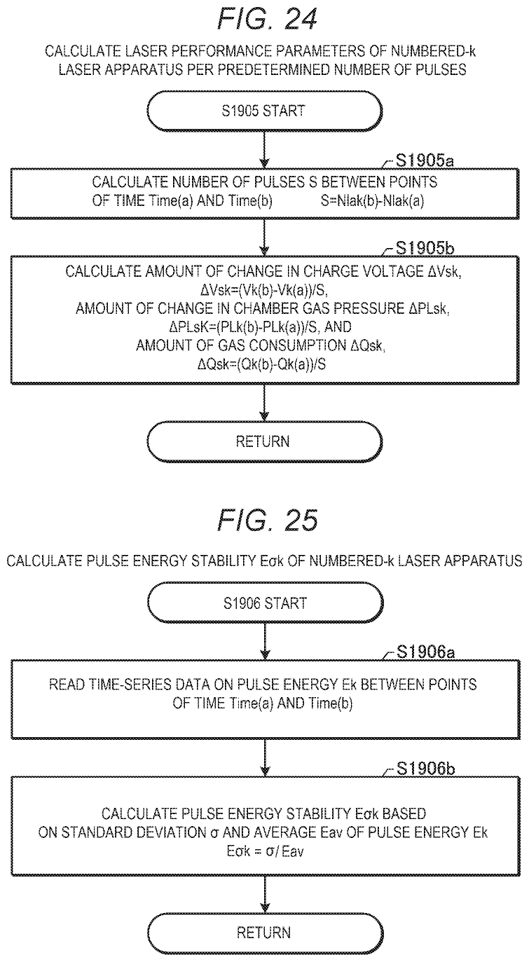

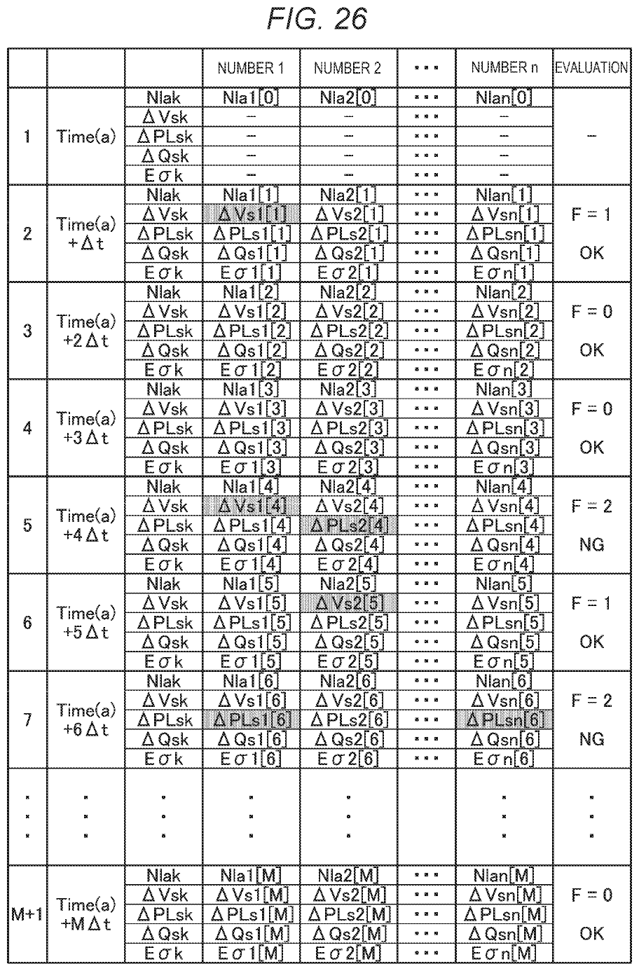

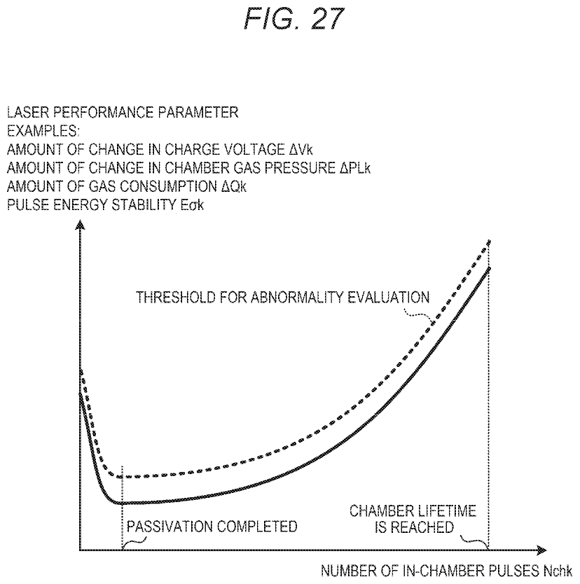

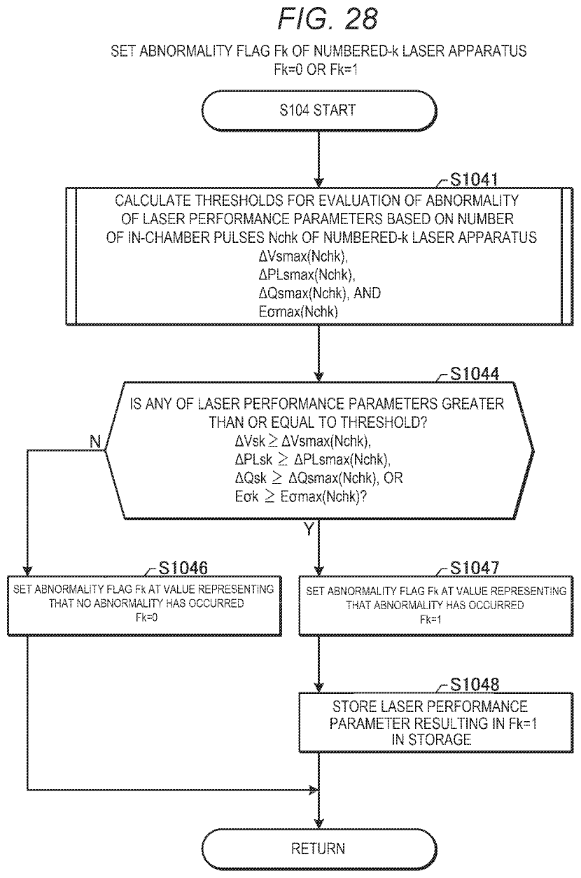

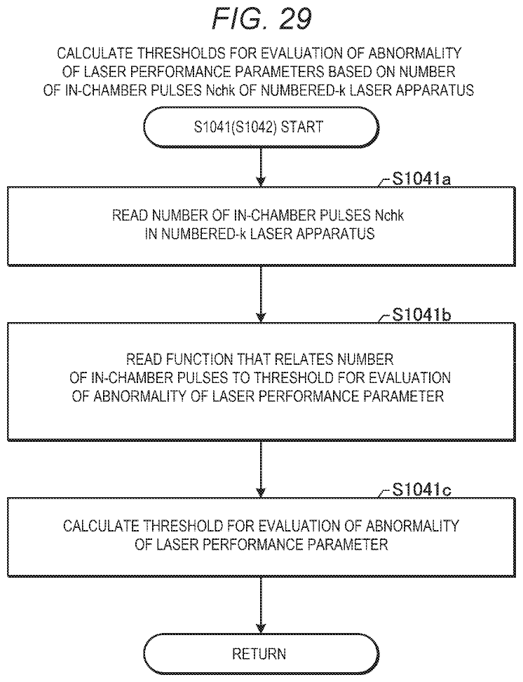

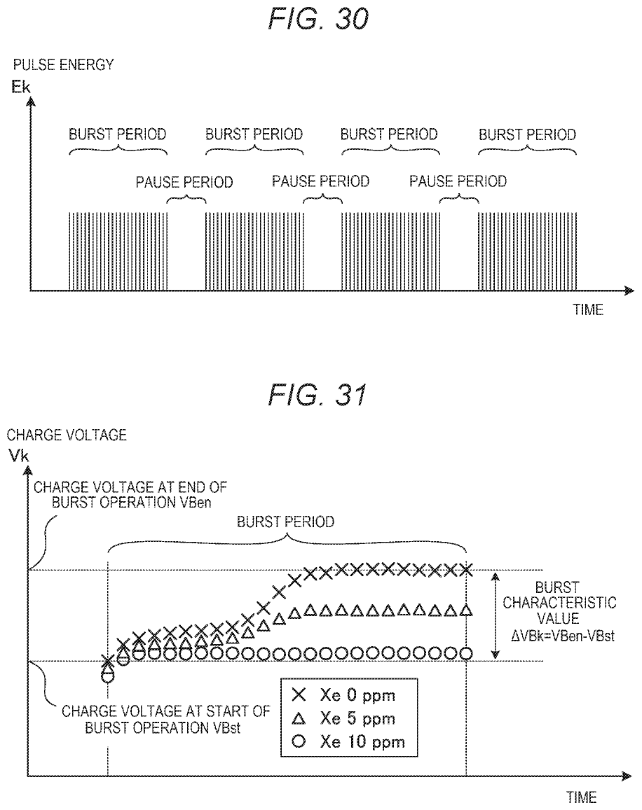

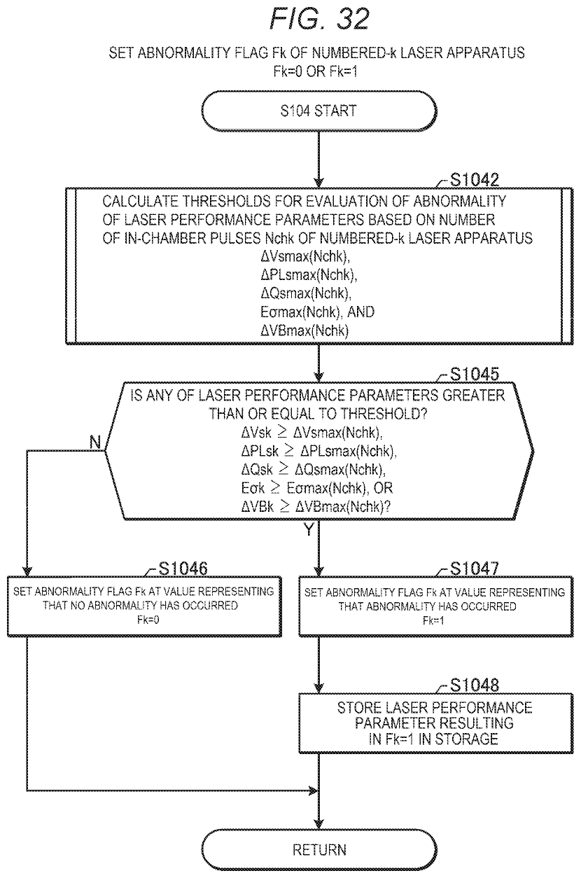

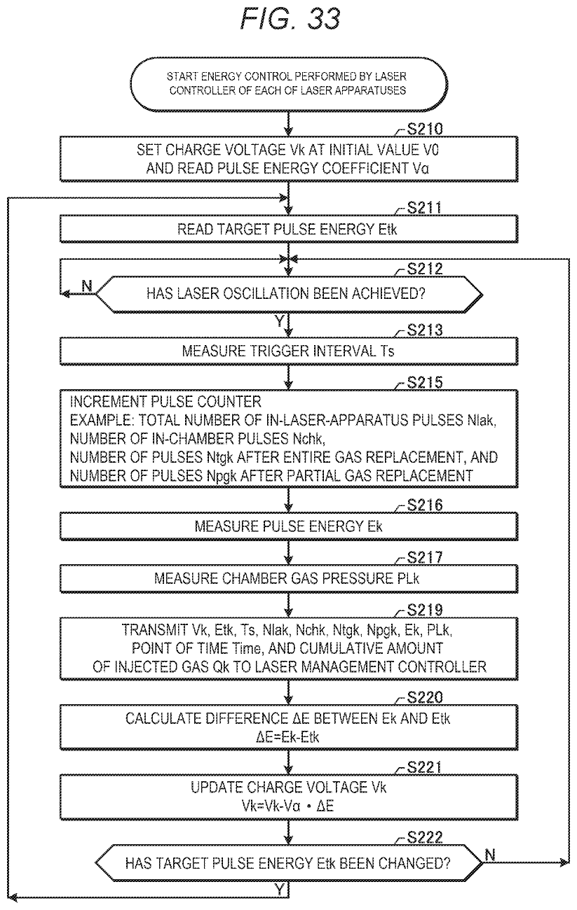

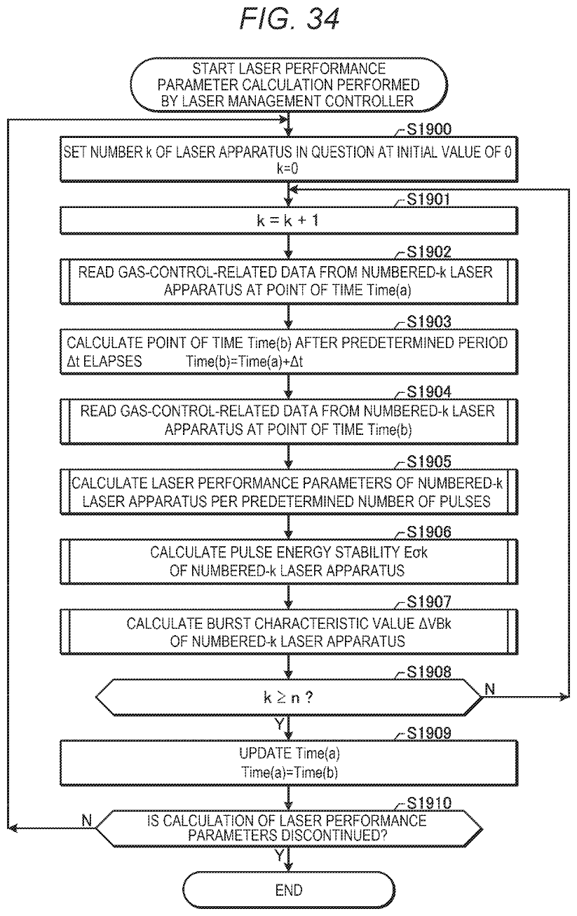

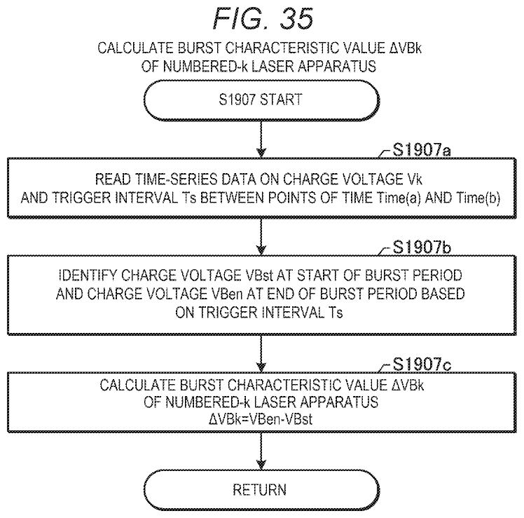

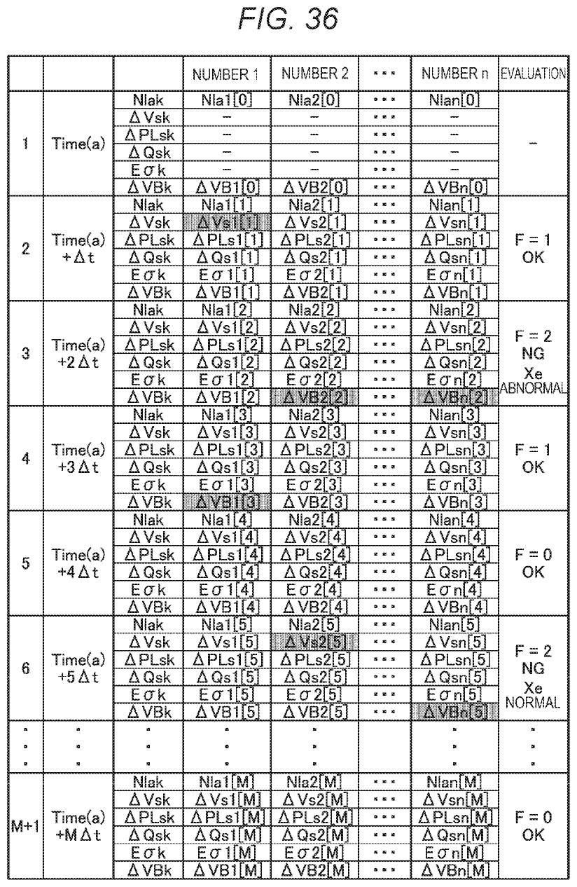

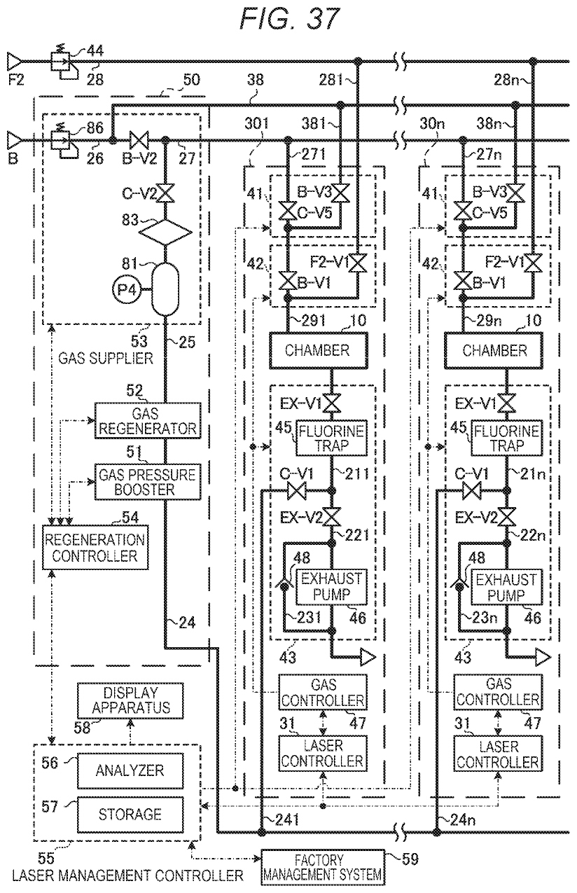

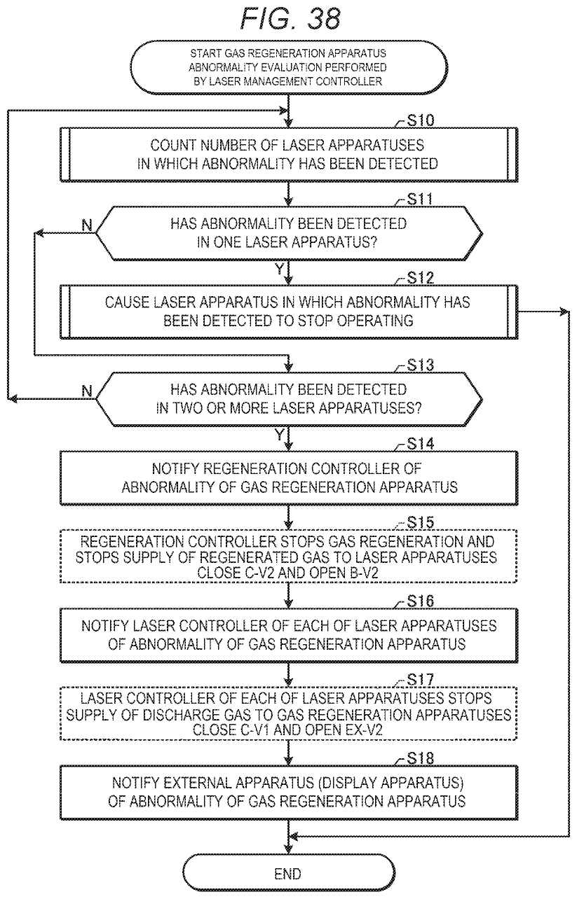

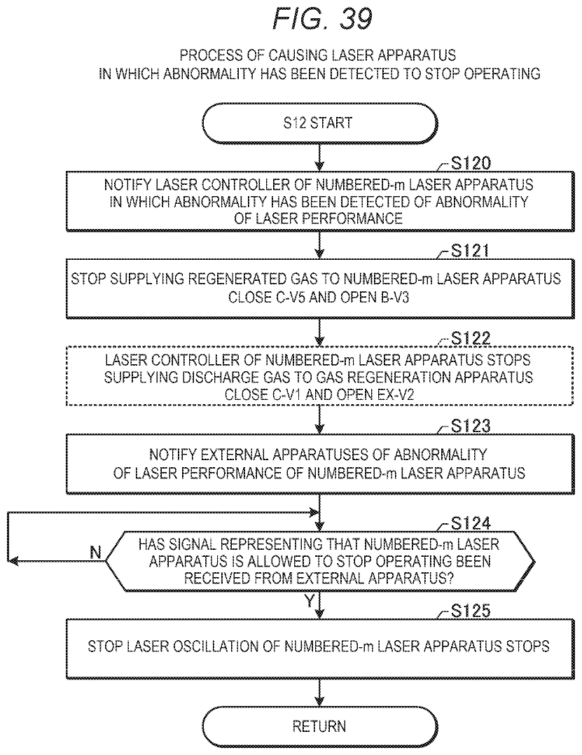

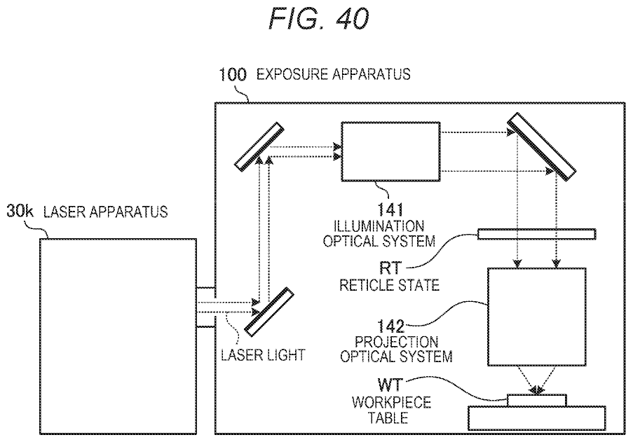

FIG. 2 schematically shows the configuration of the laser apparatus 30k shown in FIG. 1. The laser apparatus 30k includes a laser controller 31, a laser oscillation system 32, and a laser gas control system 40. The laser apparatus 30k may further include an amplifier that is not shown but includes at least one chamber to amplify laser light outputted from the laser oscillation system 32.

The laser apparatus 30k is used along with an exposure apparatus 100. Laser light outputted from the laser apparatus 30k enters the exposure apparatus 100. The exposure apparatus 100 includes an exposure apparatus controller 110. The exposure apparatus controller 110 is configured to control the exposure apparatus 100. The exposure apparatus controller 110 is configured to transmit a target pulse energy setting signal and a light emission trigger signal to the laser controller 31 provided in the laser apparatus 30k.

The laser controller 31 is a computer system configured to control the laser oscillation system 32 and the laser gas control system 40. The laser controller 31 is configured to receive measured data from a power monitor 17 and a chamber pressure sensor P1 provided in the laser oscillation system 32.

1.1.1.1 Laser Oscillation System

The laser oscillation system 32 includes a chamber 10, a charger 12, a pulse power module 13, a line narrowing module 14, an output coupling mirror 15, the chamber pressure sensor P1, and the power monitor 17.

The chamber 10 is disposed in the optical path of a laser resonator formed of the line narrowing module 14 and the output coupling mirror 15. The chamber 10 is provided with two windows 10a and 10b. The chamber 10 accommodates a pair of discharge electrodes 11a and 11b. The chamber 10 contains the laser gas.

The charger 12 holds electrical energy to be supplied to the pulse power module 13. The pulse power module 13 includes a switch 13a. The pulse power module 13 is configured to apply pulse voltage between the pair of discharge electrodes 11a and 11b.

The line narrowing module 14 includes a prism 14a and a grating 14b. The output coupling mirror 15 is formed of a partially reflective mirror. The line narrowing module 14 may be replaced with a high-reflectance mirror that is not shown.

The chamber pressure sensor P1 is configured to measure the overall pressure of the laser gas in the chamber 10. In the following description, the overall pressure of the laser gas in the chamber 10 is called a chamber gas pressure in some cases. The chamber pressure sensor P1 is configured to transmit measured data on the chamber gas pressure to the laser controller 31 and a gas controller 47 provided in the laser gas control system 40.

The power monitor 17 includes a beam splitter 17a, a light collection lens 17b, and an optical sensor 17c. The beam splitter 17a is disposed in the optical path of the laser light outputted through the output coupling mirror 15. The beam splitter 17a is configured to transmit part of the laser light outputted through the output coupling mirror 15 at high transmittance toward the exposure apparatus 100 and reflect the remainder of the laser light. The light collection lens 17b and the optical sensor 17c are disposed in the optical path of the laser light reflected off the beam splitter 17a. The light collection lens 17b is configured to focus the laser light reflected off the beam splitter 17a onto the optical sensor 17c. The optical sensor 17c is configured to transmit, as the measured data, an electric signal according to the pulse energy of the laser light focused by the light collection lens 17b to the laser controller 31.

1.1.1.2 Laser Gas Control System

The laser gas control system 40 includes the gas controller 47, a gas supplier 42, and a gas exhauster 43. The gas controller 47 is a computer system configured to control the gas supplier 42 and the gas exhauster 43. The gas controller 47 is configured to transmit and receive signals to and from the laser controller 31. The gas controller 47 is configured to receive the measured data outputted from the chamber pressure sensor P1 provided in the laser oscillation system 32.

The gas supplier 42 includes part of a pipe 28k connected to the fluorine-containing gas supply source F2 and part of a pipe 29k connected to the chamber 10 provided in the laser oscillation system 32. The pipe 28k is connected to the pipe 29k in the gas supplier 42 to allow the fluorine-containing gas supply source F2 to supply the chamber 10 with a fluorine-containing gas.

The gas supplier 42 includes a valve F2-V1 provided in the pipe 28k, as shown in FIG. 1. The supply of the fluorine-containing gas from the fluorine-containing gas supply source F2 to the chamber 10 via the pipe 29k is controlled by opening and closing the valve F2-V1. The operation of opening and closing the valve F2-V1 is controlled by the gas controller 47.

The gas supplier 42 further includes part of a pipe 27k connected to and between the gas regeneration apparatus 50 and the pipe 29k, as shown in FIG. 2. The pipe 27k is connected to the pipe 29k in the gas supplier 42 to allow the gas regeneration apparatus 50 to supply the chamber 10 with the buffer gas.

The gas supplier 42 includes a valve B-V1 provided in the pipe 27k, as shown in FIG. 1. The supply of the buffer gas from the gas regeneration apparatus 50 to the chamber 10 via the pipe 29k is controlled by opening and closing the valve B-V1. The operation of opening and closing the valve B-V1 is controlled by the gas controller 47.

The gas exhauster 43 includes part of a pipe 21k connected to the chamber 10 provided in the laser oscillation system 32 and part of a pipe 22k connected to an exhaust processor and other components that are external to the laser apparatus but are not shown, as shown in FIG. 2. The pipe 21k is connected to the pipe 22k in the gas exhauster 43 to allow the discharge gas discharged from the chamber 10 to be exhausted out of the laser apparatus.

The gas exhauster 43 includes a valve EX-V1 provided in the pipe 21k and a fluorine trap 45 provided in the pipe 21k, as shown in FIG. 1. The valve EX-V1 and the fluorine trap 45 are disposed in the presented order from the side facing the chamber 10. Supply of the discharge gas from the chamber 10 to the fluorine trap 45 is controlled by opening and closing the valve EX-V1. The operation of opening and closing the valve EX-V1 is controlled by the gas controller 47.

The fluorine trap 45 is configured to trap the fluorine gas and fluorine compounds contained in the discharge gas discharged from the chamber 10. A processing agent that traps the fluorine gas and the fluorine compounds contains, for example, the combination of zeolite and a calcium oxide. The fluorine gas therefore reacts with the calcium oxide to generate a calcium fluoride and oxygen gas. The calcium fluoride is left in the fluorine trap 45, and the oxygen gas is trapped by an oxygen trap 72, which will be described later. Part of impurity gases that have not been completely removed by the calcium oxide, such as the fluorine compounds, are adsorbed by the zeolite.

The gas exhauster 43 further includes a valve EX-V2 provided in the pipe 22k and an exhaust pump 46 provided in the pipe 22k. The valve EX-V2 and the exhaust pump 46 are disposed in the presented order from the side facing the chamber 10. Exhaust of the discharge gas out of the laser apparatus via the outlet of the fluorine trap 45 is controlled by opening and closing the valve EX-V2. The operation of opening and closing the valve EX-V2 is controlled by the gas controller 47. The exhaust pump 46 is configured to forcibly exhaust the laser gas in the chamber 10 with the valves EX-V1 and EX-V2 open in such a way that the pressure of the laser gas becomes lower than or equal to the atmospheric pressure. The operation of the exhaust pump 46 is controlled by the gas controller 47.

The gas exhauster 43 includes a bypass pipe 23k. The bypass pipe 23k is connected to and between the pipe 22k on the inlet side of the exhaust pump 46 and the pipe 22k on the outlet side of the exhaust pump 46. The gas exhauster 43 includes a check valve 48 provided in the bypass pipe 23k. The check valve 48 is configured to exhaust, when the valves EX-V1 and EX-V2 are opened, part of the laser gas in the chamber 10 filled therewith so that the laser gas pressure is higher than or equal to the atmospheric pressure.

The gas exhauster 43 further includes part of a pipe 24k. The pipe 24k is connected to and between the gas regeneration apparatus 50 and the portion where the pipes 21k and 22k are connected to each other. The pipe 24k is connected to the portion where the pipes 21k and 22k are connected to each other to allow the discharge gas discharged from the chamber 10 to be supplied to the gas regeneration apparatus 50. The gas exhauster 43 includes a valve C-V1 provided in the pipe 24k. The supply of the discharge gas via the outlet of the fluorine trap 45 to the gas regeneration apparatus 50 is controlled by opening and closing the valve C-V1. The operation of opening and closing the valve C-V1 is controlled by the gas controller 47.

1.1.2 Gas Regeneration Apparatus

FIG. 3 schematically shows the configuration of the gas regeneration apparatus 50 shown in FIG. 1. The gas regeneration apparatus 50 includes a gas pressure booster 51, a gas regenerator 52, a gas supplier 53, and a regeneration controller 54.

The gas regeneration apparatus 50 includes part of the pipe 24, part of the pipe 27, and a pipe 25. The pipe 24 is connected to the gas exhauster 43 of the laser gas control system 40 via the pipe 24k. The pipe 27 is connected to the gas supplier 42 of the laser gas control system 40 via the pipe 27k. The pipe 25 is connected to and between the pipes 24 and 27.

The laser gas regeneration apparatus 50 further includes part of a pipe 26 connected to the buffer gas supply source B. The pipe 26 is connected to the portion where the pipes 25 and 27 are connected to each other. The buffer gas supply source B is, for example, a gas cylinder containing the buffer gas. In the present disclosure, the buffer gas that has been supplied from the buffer gas supply source B but has not reached the chamber 10 is distinguished from the regenerated gas supplied via the pipe 25 and referred to as a new gas in some cases.

1.1.2.1 Gas Pressure Booster

The gas pressure booster 51 includes a filter 61, a recovery tank 63, a pressure boosting pump 64, a boosted pressure gas tank 65, and a regulator 66. The filter 61, the recovery tank 63, the pressure boosting pump 64, the boosted pressure gas tank 65, and the regulator 66 are disposed along the pipe 24 in the presented order from the side facing the gas exhauster 43.

The filter 61 is configured to trap particles contained in the discharge gas supplied from the gas exhauster 43.

The recovery tank 63 is a container that contains the discharge gas. A recovery pressure sensor P2 is attached to the recovery tank 63.

The pressure boosting pump 64 is configured to boost the pressure of the discharge gas and output the boosted pressure gas. The pressure boosting pump 64 is formed, for example, of a diaphragm or bellows pump that restricts contamination of the discharge gas with oil to a small amount.

The boosted pressure gas tank 65 is a container that contains the boosted pressure gas having passed through the pressure boosting pump 64. A boosted pressure sensor P3 is attached to the boosted pressure gas tank 65.

The regulator 66 is configured to set the pressure of the boosted pressure gas supplied from the boosted pressure gas tank 65 at a predetermined value and supply the resultant gas to the gas regenerator 52.

1.1.2.2 Gas Regenerator

The gas regenerator 52 includes a mass flow controller 71, the oxygen trap 72, a xenon trap 73, and a purifier 74. The mass flow controller 71, the oxygen trap 72, the xenon trap 73, and the purifier 74 are disposed along the pipe 24 in the presented order from the side facing the gas pressure booster 51.

The gas regenerator 52 further includes a xenon adder 75. The xenon adder 75 is disposed between the pipes 24 and 25.

The mass flow controller 71 is configured to control the flow rate of the boosted pressure gas supplied from the gas pressure booster 51.

The oxygen trap 72 is configured to trap the oxygen gas from the boosted pressure gas. A processing agent that traps the oxygen gas contains at least one of a nickel-based (Ni-based) catalyst, a copper-based (Cu-based) catalyst, and a composite thereof. The oxygen trap 72 includes a heater and a temperature adjuster that are not shown.

The xenon trap 73 is, for example, a device using a Ca—X-type zeolite, a Na—Y-type zeolite, or activated carbon, which can each selectively adsorb xenon. The xenon trap 73 includes a heater and a temperature adjuster that are not shown.

The purifier 74 is, for example, a metal filter containing a metal getter. The metal getter is, for example, a zirconium-based (Zr-based) alloy. The purifier 74 is configured to trap the impurity gases from the laser gas.

The xenon adder 75 includes a xenon-containing gas cylinder 76, a pipe 20, a regulator 77, a mass flow controller 78, and a mixer 79.

One end of the pipe 20 is connected to the xenon-containing gas cylinder 76. The regulator 77 and the mass flow controller 78 are disposed along the pipe 20. The regulator 77 and the mass flow controller 78 are arranged in the presented order from the side facing the xenon-containing gas cylinder 76. The mixer 79 is disposed in the position where the pipe 20 merges with the pipe 24. The output of the mixer 79 is connected to the pipe 25.

The xenon-containing gas cylinder 76 is a gas cylinder that contains a xenon-containing gas. The xenon-containing gas is a laser gas formed of an argon gas and a neon gas mixed with a xenon gas. The concentration of the xenon gas contained in the xenon-containing gas is adjusted to be higher than the xenon gas concentration optimal for an ArF excimer laser apparatus.

The regulator 77 is configured to set the pressure of the xenon-containing gas supplied from the xenon-containing gas cylinder 76 at a predetermined value and supply the resultant xenon-containing gas to the mass flow controller 78. The mass flow controller 78 is configured to control the flow rate of the xenon-containing gas supplied from the regulator 77.

The mixer 79 is configured to uniformly mix the regenerated gas supplied via the pipe 24 with the xenon-containing gas supplied via the pipe 20.

When the laser apparatuses 301 to 30n are each a KrF or XeF excimer laser apparatus, the xenon trap 73 or the xenon adder 75 may not be provided.

1.1.2.3 Gas Supplier

The gas supplier 53 includes a supply tank 81, a filter 83, a valve C-V2, a regulator 86, and a valve B-V2. The supply tank 81, the filter 83, and the valve C-V2 are arranged along the pipe 25 in the presented order from the side facing the gas regenerator 52. The regulator 86 and the valve B-V2 are arranged along the pipe 26 in the presented order from the side facing the buffer gas supply source B.

The supply tank 81 is a container that contains the regenerated gas supplied from the gas regenerator 52. A supply pressure sensor P4 is attached to the supply tank 81.

The filter 83 is configured to trap particles generated in the gas regeneration apparatus 50 from the regenerated gas.

The valve C-V2 is configured to switch whether or not the regenerated gas supplied from the gas regenerator 52 is supplied to the pipe 27.

The regulator 86 is configured to set the pressure at which the new gas is supplied from the buffer gas supply source B to the pipe 27. The regulator 86 is configured to set the new gas supply pressure at a value, for example, greater than or equal to 5,000 hPa but smaller than or equal to 6,000 hPa.

The valve B-V2 is configured to switch whether or not the new gas supplied from the buffer gas supply source B is supplied to the pipe 27.

1.1.2.4 Gas Regeneration Controller

The regeneration controller 54 is a computer system for controlling the gas regeneration apparatus 50. The regeneration controller 54 includes a gas pressure boost controller 541, a gas regeneration controller 542, and a gas supply controller 543. The gas pressure boost controller 541 is configured to transmit and receive signals to and from the gas pressure booster 51. The gas regeneration controller 542 is configured to transmit and receive signals to and from the gas regenerator 52. The gas supply controller 543 is configured to transmit and receive signals to and from the gas supplier 53. The regeneration controller 54 is configured to transmit and receive signals to and from the laser controller 31 provided in each of the laser apparatuses 301 to 30n.

1.2 Operation

### 1.2.1 Operation of Laser Apparatus

### 1.2.1.1 Operation of Laser Oscillation System

In the laser apparatus 30k, the laser controller 31 transmits a charge voltage setting signal to the charger 12 based on the target pulse energy setting signal received from the exposure apparatus controller 110. The laser controller 31 further transmits a light emission trigger to the switch 13a provided in the pulse power module (PPM) 13 based on a light emission trigger signal received from the exposure apparatus controller 110.

The switch 13a of the pulse power module 13 is turned on upon reception of the light emission trigger from the laser controller 31. When the switch 13a is turned on, the pulse power module 13 produces pulsed high voltage from the electrical energy charged in the charger 12. The pulse power module 13 applies the high voltage between the pair of discharge electrodes 11a and 11b.

When the high voltage is applied between the pair of discharge electrodes 11a and 11b, discharge occurs in the gap between the pair of discharge electrodes 11a and 11b. The energy of the discharge excites the laser gas in the chamber 10, and the excited laser gas transitions to a higher energy level. Thereafter, when the excited laser gas transitions to a lower energy level, the laser gas emits light having a wavelength according to the difference between the energy levels.

The light produced in the chamber 10 exits out of the chamber 10 through the windows 10a and 10b. The light having exited through the window 10a of the chamber 10 is incident on the grating 14b with the beam width of the light increased by the prism 14a. The light incident via the prism 14a on the grating 14b is reflected off a plurality of grooves of the grating 14b and diffracted in the direction according to the wavelength of the light. The grating 14b is so disposed in the Littrow arrangement that the angle of incidence of the light incident via the prism 14a on the grating 14b coincides with the angle of diffraction of the diffracted light having a desired wavelength. The light having the desired wavelength and light having wavelengths close thereto thus return to the chamber 10 via the prism 14a.

The output coupling mirror 15 transmits and outputs part of the light having exited through the window 10b of the chamber 10 and reflects the remainder of the light to cause the reflected light to return into the chamber 10.

The light having exited out of the chamber 10 thus travels back and forth between the line narrowing module 14 and the output coupling mirror 15 and is amplified whenever passing through the discharge space between the pair of discharge electrodes 11a and 11b, resulting in laser oscillation. The light undergoes the line narrowing whenever deflected back by the line narrowing module 14. The thus amplified and line-narrowed light is outputted as the laser light through the output coupling mirror 15.

The power monitor 17 detects the pulse energy of the laser light outputted through the output coupling mirror 15. The power monitor 17 transmits data on the detected pulse energy to the laser controller 31.

The laser controller 31 performs feedback control on the charge voltage set in the charger 12 based on the measured pulse energy data received from the power monitor 17 and the target pulse energy setting signal received from the exposure apparatus controller 110.

1.2.1.2 Operation of Laser Gas Control System

In the laser apparatus 30k, the laser gas control system 40 performs partial gas replacement based on the following control performed by the gas controller 47.

The gas controller 47 controls the gas supplier 42 to cause it to inject a first predetermined amount of buffer gas into the chamber 10 and inject a second predetermined amount of fluorine-containing gas into the chamber 10. The gas controller 47 then controls the gas exhauster 43 to cause it to discharge the laser gas the amount of which corresponds to the sum of the first predetermined amount and the second predetermined amount from the chamber 10.

The partial gas replacement is performed, for example, whenever the number of pulses outputted from the chamber reaches a fixed value. Instead, the partial gas replacement is performed whenever the period for which the chamber has been operated reaches a fixed value.

To inject the first predetermined amount of buffer gas into the chamber 10, the gas supplier 42 opens and then closes the valve B-V1. The buffer gas is either the new gas supplied from the buffer gas supply source B via the valve B-V2 or the regenerated gas having impurities reduced in the gas regeneration apparatus 50 and supplied via the valve C-V2.

To inject the second predetermined amount of fluorine-containing gas into the chamber 10, the gas supplier 42 opens and then closes the valve F2-V1.

The gas exhauster 43 opens the valves EX-V1 and EX-V2 to exhaust the discharge gas discharged from the chamber 10 out of the laser apparatus. The gas exhauster 43 opens the valves EX-V1 and C-V1 to supply the discharge gas discharged from the chamber 10 to the gas regeneration apparatus 50.

The partial gas replacement described above allows a predetermined amount of gas having a small amount of impurities to be supplied to the chamber 10 and the gas in the chamber 10 to be discharged by the amount equal to the amount of the supplied gas. The partial gas replacement can thus reduce the impurities, such as hydrogen fluoride (HF), carbon tetrafluoride (CF₄), silicon tetrafluoride (SiF₄), nitrogen trifluoride (NF₃), and hexafluoroethane (C₂F₆) in the chamber 10.

1.2.2 Operation of Gas Regeneration Apparatus

The gas regeneration apparatus 50 reduces the impurities from the discharge gas discharged from each of the laser apparatuses 301 to 30n as will be described below. The gas regeneration apparatus 50 supplies each of laser apparatuses 301 to 30n with the regenerated gas having reduced impurities.

In the gas pressure booster 51, the filter 61 traps the particles produced by the discharge in the chamber 10 from the discharge gas having passed through the fluorine trap 45.

The recovery tank 63 contains the discharge gas having passed through the filter 61. The recovery pressure sensor P2 measures the gas pressure in the recovery tank 63. The recovery pressure sensor P2 outputs data on the measured gas pressure to the gas pressure boost controller 541.

The pressure boosting pump 64 boosts the pressure of the discharge gas contained in the recovery tank 63 and outputs the boosted pressure gas to the boosted pressure gas tank 65. The gas pressure boost controller 541 controls the pressure boosting pump 64 in such a way that the pressure boosting pump 64 operates when the gas pressure in the recovery tank 63 that is received from the recovery pressure sensor P2 is, for example, higher than or equal to the atmospheric pressure.

The boosted pressure gas tank 65 contains the boosted pressure gas having passed through the pressure boosting pump 64. The boosted pressure sensor P3 measures the gas pressure in the boosted pressure gas tank 65. The boosted pressure sensor P3 outputs data on the measured gas pressure to the gas pressure boost controller 541.

In the gas regenerator 52, the oxygen trap 72 traps the oxygen gas generated in the reaction between the fluorine gas and the calcium oxide in the fluorine trap 45. The gas regeneration controller 542 controls the heater and the temperature adjuster in the oxygen trap 72, which are not shown, in such a way that an optimum temperature at which the oxygen trap 72 traps the oxygen gas is achieved.

The xenon trap 73 removes the xenon gas from the boosted pressure gas having passed through the oxygen trap 72. The xenon gas concentration in the boosted pressure gas thus lowers, and variation in the xenon gas concentration decreases. The gas regeneration controller 542 controls the heater and the temperature adjuster in the xenon trap 73, which are not shown, in such a way that an optimum temperature at which the xenon trap 73 adsorbs the xenon gas is achieved.

The purifier 74 traps minute amounts of impurity gases, such as water vapor, oxygen gas, carbon monoxide gas, carbon dioxide gas, and nitrogen gas, from the discharge gas having passed through the oxygen trap 72.

The flow rate controlled by the mass flow controller 71 and the flow rate controlled by the mass flow controller 78 are set by the gas regeneration controller 542. The flow rates are set so that the xenon gas in the regenerated gas that is the mixture from the mixer 79 has a desired concentration. The regenerated gas that is mixed by the mixer 79 is supplied to the supply tank 81 via the pipe 25.

In the gas supplier 53, the supply tank 81 contains the regenerated gas supplied from the xenon adder 75. The supply pressure sensor P4 measures the gas pressure in the supply tank 81. The supply pressure sensor P4 outputs data on the measured gas pressure to the gas supply controller 543.

The filter 83 traps the particles produced in the gas regeneration apparatus 50 from the regenerated gas supplied from the supply tank 81.

The supply of the regenerated gas from the gas regeneration apparatus 50 to the gas supplier 42 via the pipe 27 is controlled by opening and closing the valve C-V2. The operation of opening and closing the valve C-V2 is controlled by the gas supply controller 543.

The supply of the new gas from the buffer gas supply source B to the gas supplier 42 via the pipe 27 is controlled by opening and closing the valve B-V2. The operation of opening and closing the valve B-V2 is controlled by the gas supply controller 543.

The gas supply controller 543 controls the valves C-V2 and B-V2 by selecting whether the valve C-V2 is closed and the valve B-V2 is opened or the valve B-V2 is closed and the valve C-V2 is opened.

1.2.2.1 Operation of Gas Pressure Boost Controller

FIG. 4 is a flowchart showing the processes carried out by the gas pressure boost controller 541 in the gas regeneration apparatus 50 shown in FIG. 1. The gas pressure boost controller 541 carries out the following processes to boost the pressure of the gas discharged from the chamber 10 and stores the pressured boosted gas. In the flowcharts of the processes carried out by the gas pressure boost controller 541, the gas regeneration controller 542, and the gas supply controller 543 in the present disclosure, each step is identified by a reference character starting with “S3.” It is assumed as a prerequisite for the processes shown below that the pipes in the gas regeneration apparatus 50 are filled with the laser gas having pressure higher than or equal to the atmospheric pressure.

First, in S300, the gas pressure boost controller 541 outputs to the laser controller 31 a signal notifying the laser controller 31 of each of the laser apparatuses of start of the discharge gas acceptance. The laser controller 31 controls the gas controller 47 based on the signal from the gas pressure boost controller 541. The gas controller 47 closes the valve EX-V2 in the gas exhauster 43 and opens the valve C-V1 in the gas exhauster 43. The discharge gas from the chamber 10 is thus supplied to the gas regeneration apparatus 50.

Instead, the laser controller 31 may control the gas controller 47 in such a way that the discharge gas from the chamber 10 is supplied to the gas regeneration apparatus 50 even when the signal is not issued from the gas pressure boost controller 541. In this case, the gas pressure boost controller 541 may not carry out the process in S300.

In S301, the gas pressure boost controller 541 then outputs to the gas regeneration controller 542 a signal notifying the gas regeneration controller 542 that the boosted pressure gas is not suppliable to the gas regenerator 52. The gas pressure boost controller 541 then carries out the following process to be ready to supply the gas regenerator 52 with the boosted pressure gas. The notification signal representing that the boosted pressure gas is not suppliable to the gas regenerator 52 is used in S322, which will be described later with reference to FIG. 5.

Thereafter, in S302, the gas pressure boost controller 541 measures the gas pressure P2 in the recovery tank 63 and the gas pressure P3 in the boosted pressure gas tank 65. The gas pressure P2 in the recovery tank 63 is outputted from the recovery pressure sensor P2. The gas pressure P3 in the boosted pressure gas tank 65 is outputted from the boosted pressure sensor P3. In the present specification, a pressure sensor and the gas pressure measured with the pressure sensor have the same reference character in some cases.

Thereafter, in S303, the gas pressure boost controller 541 evaluates whether or not the gas pressure P2 in the recovery tank 63 is greater than a threshold P2 min and the gas pressure P3 in the boosted pressure gas tank 65 is smaller than a threshold P3max2. The threshold P2 min is set at a value, for example, slightly smaller than the atmospheric pressure. The threshold P2 min is set at a value, for example, greater than or equal to 900 hPa but smaller than or equal to 1,000 hPa. The threshold value P3max2 is set, for example, at designed upper-limit pressure for the pressure boosting pump 64 or the boosted pressure gas tank 65.

When the gas pressure P2 in the recovery tank 63 is greater than the threshold P2 min and the gas pressure P3 in the boosted pressure gas tank 65 is smaller than the threshold P3max2 (YES in S303), the gas pressure boost controller 541 proceeds to the process in S304.

When the gas pressure P2 in the recovery tank 63 is smaller than or equal to the threshold P2 min or the gas pressure P3 in the boosted pressure gas tank 65 is greater than or equal to the threshold P3max2 (NO in S303), the gas pressure boost controller 541 proceeds to the process in S305.

In a flowchart in the present disclosure, “Y” represents the YES result of evaluation, and “N” represents the NO result of the evaluation.

In S304, the gas pressure boost controller 541 turns on the pressure boosting pump 64. The boosted pressure gas tank 65 is thus filled with the boosted pressure gas. The gas pressure boost controller 541 then proceeds to the process in S306.

In S305, the gas pressure boost controller 541 turns off the pressure boosting pump 64. When the gas pressure P2 in the recovery tank 63 is smaller than or equal to the threshold P2 min, the laser gas is not likely to having been discharged from the corresponding one of the laser apparatuses 301 to 30n. In this case, since driving the pressure boosting pump 64 does not lead to efficient boosting, the gas pressure boost controller 541 turns off the pressure boosting pump 64. When the gas pressure P3 in the boosted pressure gas tank 65 is greater than or equal to the threshold P3max2, further driving the pressure boosting pump 64 causes the pressure boosting pump 64 or the boosted pressure gas tank 65 to operate beyond its designed use range, and the gas pressure boost controller 541 therefore turns off the pressure boosting pump 64. The gas pressure boost controller 541 then proceeds to the process in S306.

In S306, the gas pressure boost controller 541 evaluates whether or not the gas pressure P3 in the boosted pressure gas tank 65 is greater than a threshold P3max. The threshold P3max is set at a value greater than the gas pressure in the chamber 10 so that the boosted pressure gas is suppliable to the gas regenerator 52. The threshold P3max may be greater than or equal to the pressure set by the regulator 86 for the buffer gas supply source B. The threshold P3max is set at a value, for example, greater than or equal to 7,000 hPa but smaller than or equal to 8,000 hPa.

When the gas pressure P3 in the boosted pressure gas tank 65 is greater than the threshold P3max (YES in S306), the gas pressure boost controller 541 proceeds to the process in S307.

When the gas pressure P3 in the boosted pressure gas tank 65 is smaller than or equal to the threshold P3max (NO in S306), the gas pressure boost controller 541 returns to the process in S301 described above. The gas pressure boost controller 541 repeats the processes from S301 to S306 until the boosted pressure gas is ready to be suppliable to the gas regenerator 52.

In S307, the gas pressure boost controller 541 outputs to the gas regeneration controller 542 a signal notifying the gas regeneration controller 542 that the boosted pressure gas is suppliable to the gas regenerator 52. The notification signal representing that the boosted pressure gas is suppliable to the gas regenerator 52 is used in S322, which will be described later with reference to FIG. 5.

Thereafter, in S308, the gas pressure boost controller 541 evaluates whether or not to stop the gas pressure boosting operation. For example, when abnormality occurs in the pressure boosting pump 64, the gas pressure boost controller 541 determines to stop the gas pressure boosting operation. When the gas pressure boost controller 541 receives from the gas regeneration controller 542 a signal representing that the gas regeneration controller 542 stops the gas generation or when the gas pressure boost controller 541 receives from the gas supply controller 543 a signal representing that the gas supply controller 543 stops the regenerated gas storage, the gas pressure boost controller 541 determines to stop the gas pressure boosting operation.

When the gas pressure boost controller 541 determines to stop the gas pressure boosting operation (YES in S308), the gas pressure boost controller 541 proceeds to the process in S309.

When the gas pressure boost controller 541 determines not to stop the gas pressure boosting operation (NO in S308), the gas pressure boost controller 541 returns to the process in S302 described above. The gas pressure boost controller 541 repeats the processes from S302 to S308 until the gas pressure P3 in the boosted pressure gas tank 65 is smaller than or equal to the threshold P3max in S306 or the gas pressure boost controller 541 determines in S308 to stop the gas pressure boosting operation.

In S309, the gas pressure boost controller 541 outputs to the gas regeneration controller 542 and the gas supply controller 543 a signal notifying the gas regeneration controller 542 and the gas supply controller 543 that the gas pressure boost controller 541 stops the gas pressure boosting operation.

Thereafter, in S310, the gas pressure boost controller 541 outputs to the laser controller 31 of each of the laser apparatuses a signal notifying the laser controller 31 of stoppage of the discharge gas acceptance.

The gas regeneration controller 542 then terminates the processes in the present flowchart.

The laser controller 31 controls the gas controller 47 based on the signal transmitted from the gas pressure boost controller 541 and notifying the laser controller 31 of stoppage of the discharge gas acceptance. The gas controller 47 closes the valve C-V1 in the gas exhauster 43 and opens the valve EX-V2 in the gas exhauster 43. The discharge gas from the chamber 10 is thus exhausted out of the laser apparatus.

The laser controller 31 may instead control the gas controller 47 in such a way that the discharge gas from the chamber 10 is thus exhausted out of the laser apparatus even when the signal is not issued from the gas pressure boost controller 541. In this case, the gas pressure boost controller 541 may not carry out the process in S310.

1.2.2.2 Operation of Gas Regeneration Controller

FIG. 5 is a flowchart showing the processes carried out by the gas regeneration controller 542 in the gas regeneration apparatus 50 shown in FIG. 1. The gas regeneration controller 542 carries out the following processes to regenerate the gas supplied from the gas pressure booster 51.

First, in S320, the gas regeneration controller 542 starts operating the oxygen trap 72 and the xenon trap 73. For example, when the temperatures of the oxygen trap 72 and the xenon trap 73 need to be raised to facilitate the adsorption of oxygen in the oxygen trap 72 and the adsorption of xenon in the xenon trap 73, the gas regeneration controller 542 transmits a control signal to the heater and the temperature adjuster in the oxygen trap 72, which are not shown, and the heater and the temperature adjuster in the xenon trap 73, which are not shown. The gas regeneration controller 542 then waits until the temperature of the oxygen trap 72 and the temperature of the xenon trap 73 each fall within an optimum temperature range. When the oxygen trap 72 or the xenon trap 73 does not need to be heated, the process in S320 may not be carried out.

Thereafter, in S321, the gas regeneration controller 542 sets each of a flow rate MFC3 controlled by the mass flow controller 71 and a flow rate MFC2 controlled by the mass flow controller 78 at 0. The gas regeneration controller 542 may instead close a valve that is not shown but is disposed on the downstream of each of the mass flow controllers 71 and 78.

Thereafter, in S322, the gas regeneration controller 542 evaluates whether or not the boosted pressure is suppliable and the regenerated gas is storable.

When the gas regeneration controller 542 receives from the gas pressure boost controller 541 the signal notifying that the boosted pressure gas is suppliable to the gas regenerator 52 in S307 described above with reference to FIG. 4, the gas regeneration controller 542 determines that the boosted pressure gas is suppliable. When the gas regeneration controller 542 receives from the gas pressure boost controller 541 the signal notifying that the boosted pressure gas is not suppliable to the gas regenerator 52 in S301 described above with reference to FIG. 4, the gas regeneration controller 542 determines that the boosted pressure gas is not suppliable.

When the gas regeneration controller 542 receives from the gas supply controller 543 a signal notifying that the regenerated gas is storable in S333, which will be described later with reference to FIG. 6, the gas regeneration controller 542 determines that the regenerated gas is storable. When the gas regeneration controller 542 receives in S333 from the gas supply controller 543 a signal notifying that the regenerated gas is not storable, the gas regeneration controller 542 determines that the regenerated gas is not storable.

When the boosted pressure gas is suppliable and the regenerated gas is storable (YES in S322), the gas regeneration controller 542 proceeds to the process in S323.

When the boosted pressure gas is not suppliable or the regenerated gas is not storable (NO in S322), the gas regeneration controller 542 returns to the process in S321 described above. The gas regeneration controller 542 repeats the processes in S321 and S322 until the boosted pressure gas is suppliable and the regenerated gas is storable.

In S323, the gas regeneration controller 542 sets the flow rate MFC3 controlled by the mass flow controller 71 at a predetermined value SCCM3, sets the flow rate MFC2 controlled by the mass flow controller 78 at a predetermined value SCCM2, and causes the gases to flow at the set flow rates. The predetermined values SCCM3 and SCCM2 are each set so that the xenon gas mixed by the mixer 79 with the regenerated gas has a desire concentration.

Thereafter, in S324, the gas regeneration controller 542 evaluates whether or not to stop the gas regeneration. For example, the gas regeneration controller 542 determines to stop the gas regeneration when any of the oxygen trap 72, the xenon trap 73, and the purifier 74 has reached its lifetime. Instead, the gas regeneration controller 542 determines to stop the gas regeneration when the gas regeneration controller 542 receives from the gas pressure boost controller 541 the signal representing that the gas pressure boost controller 541 stops the gas pressure boosting operation or when the gas regeneration controller 542 receives from the gas supply controller 543 the signal representing that the gas supply controller 543 stops the regenerated gas storage.

When the gas regeneration controller 542 determines to stop the gas regeneration (YES in S324), the gas regeneration controller 542 proceeds to the process in S325.

When the gas regeneration controller 542 determines not to stop the gas regeneration (NO in S324), the gas regeneration controller 542 returns to the process in S322 described above. The gas regeneration controller 542 repeats the processes from S322 to S324 until the boosted pressure is not suppliable or the regenerated gas is not storable in S322 or the gas regeneration is stopped in S324.

In S325, the gas regeneration controller 542 outputs a signal notifying that the gas regeneration controller 542 stops the gas regeneration to the gas pressure boost controller 541 and the gas supply controller 543.

The gas regeneration controller 542 then terminates the processes in the present flowchart.

1.2.2.3 Operation of Gas Supply Controller

FIG. 6 is a flowchart showing the processes carried out by the gas supply controller 543 in the gas regeneration apparatus 50 shown in FIG. 1. The gas supply controller 543 carries out the following processes to store the regenerated gas regenerated by the gas regenerator 52 and supply the regenerated gas to the chamber 10.

First, in S330, the gas supply controller 543 outputs to the laser controller 31 of each of the laser apparatuses a signal notifying that the regenerated gas is not suppliable to the chamber 10.

Thereafter, in S331, the gas supply controller 543 closes the valve C-V2 and opens the valve B-V2. The gas supplier 53 thus supplies the chamber 10 with the new gas until the gas supplier 53 is ready to supply the chamber 10 with the regenerated gas.

Thereafter, in S332, the gas supply controller 543 measures gas pressure P4 in the supply tank 81. The gas pressure P4 in the supply tank 81 is outputted from the supply pressure sensor P4.

Thereafter, in S333, the gas supply controller 543 notifies the gas pressure boost controller 541 and the gas regeneration controller 542 that the regenerated gas is storable or the regenerated gas is not storable. For example, when the gas pressure P4 in the supply tank 81 is lower than a designed upper-limit pressure for the supply tank 81, the gas supply controller 543 notifies each of the controllers that the regenerated gas is storable. When the gas pressure P4 in the supply tank 81 is higher than or equal to the designed upper-limit pressure for the supply tank 81, the gas supply controller 543 notifies each of the controllers that the regenerated gas is not storable. The signal notifying that the regenerated gas is storable or not is used in S322 in FIG. 5.

Thereafter, in S334, the gas supply controller 543 evaluates whether or not the gas pressure P4 in the supply tank 81 is greater than a threshold P4 min. The threshold P4 min is set at a value higher than the gas pressure in the chamber 10 so that the regenerated gas is suppliable to the chamber 10. The threshold P4 min may be equal to the pressure set by the regulator 86 for the buffer gas supply source B. The threshold P4 min may be a value smaller than the threshold P3max of the gas pressure P3 in the boosted pressure gas tank 65 described above with reference to FIG. 5. The threshold P4 min is set at a value, for example, greater than or equal to 7,000 hPa but smaller than or equal to 8,000 hPa.

When the gas pressure P4 in the supply tank 81 is greater than the threshold P4 min (YES in S334), the gas supply controller 543 proceeds to the process in S335.

When the gas pressure P4 in the supply tank 81 is smaller than or equal to the threshold P4 min (NO in S334), the gas supply controller 543 returns to the process in S330 described above. The gas supply controller 543 repeats the processes from S330 to S334 until the gas supply controller 543 is ready to supply the regenerated gas to the chamber 10.

In S335, the gas supply controller 543 closes the valve B-V2 and opens the valve C-V2. The supply of the new gas to the chamber 10 is thus blocked, and the regenerated gas is suppliable.

Thereafter, in S336, the gas supply controller 543 outputs to the laser controller 31 of each of the laser apparatuses a signal notifying that the regenerated gas is suppliable to the chamber 10.

Thereafter, in S337, the gas supply controller 543 evaluates whether or not the gas supply controller 543 stops the gas storage. The gas supply controller 543 determines to stop the gas storage, for example, when the gas supply controller 543 receives from the gas pressure boost controller 541 the signal representing that the gas pressure boost controller 541 stops the discharge gas pressure boosting operation or when the gas supply controller 543 receives from the gas regeneration controller 542 the signal representing that the gas regeneration controller 542 stops the gas regeneration.

When the gas supply controller 543 determines to stop the gas storage (YES in S337), the gas supply controller 543 proceeds to the process in S338.

When the gas supply controller 543 determines not to stop the gas storage (NO in S337), the gas supply controller 543 returns to the process in S332 described above. The gas supply controller 543 repeats the processes from S332 to S337 until the gas pressure P4 in the supply tank 81 becomes smaller than or equal to the threshold P4 min in S334 or it is determined that the gas supply controller 543 determines to stop the gas storage in S337.

In S338, the gas supply controller 543 outputs to the gas pressure boost controller 541 and the gas regeneration controller 542 a signal notifying that the gas supply controller 543 stops the gas storage.

The gas supply controller 543 then terminates the processes in the present flowchart.

The present embodiment has been described with reference to the laser gas management system used with an ArF excimer laser apparatus, a KrF excimer laser apparatus, or an XeF excimer laser apparatus, but not necessarily, and may be used with an XeCl excimer laser apparatus.

When the laser gas management system is used with an XeCl excimer laser apparatus, the buffer gas is, for example, a laser gas containing a xenon gas and a neon gas, and the fluorine-containing gas is a laser gas containing a hydrogen chloride gas, a xenon gas, and a neon gas in place of the laser gas containing chlorine. A gas supply source containing hydrogen chloride may be connected to the laser gas management system in place of the fluorine-containing gas supply source F2.

In the case of an XeCl excimer laser apparatus, the xenon trap 73 or the xenon adder 75 may not be provided.

The fluorine trap 45 may be changed to a hydrogen chloride trap that is not shown. For example, the hydrogen chloride trap includes the combination of zeolite and calcium hydroxide. Calcium hydroxide and hydrogen chloride may be caused to react with each other to produce calcium chloride and water for trapping the hydrogen chloride. The water produced by the hydrogen chloride trap may be trapped by a water trap that is not shown but is disposed in place of the oxygen trap 72. The material of the water trap may, for example, be zeolite.

1.3 Problems

The impurity reduction ability of the gas regeneration apparatus 50 lowers in some case, for example, when any of the variety of traps described above reaches its lifetime. If the gas regeneration apparatus 50 is kept driven in the state in which such abnormality occurs in the gas regeneration apparatus 50, the performance of the plurality of laser apparatuses 301 to 30n connected to the gas regeneration apparatus 50 is likely to deteriorate. As a result, the plurality of laser apparatuses 301 to 30n connected to the gas regeneration apparatus 50 could simultaneously stop operating.

As a method for monitoring whether or not abnormality has occurred in the gas regeneration apparatus 50, it is conceivable to attach a component analyzer to the gas regeneration apparatus 50 and detect the concentrations of the impurities in the regenerated gas. A component analyzer is, however, expensive and requires a large installation space.

Laser gas management systems according to embodiments of the present disclosure each evaluate whether or not at least one parameter of each of the laser apparatuses 301 to 30n exceeds a range determined in advance. The laser gas management system then determines that abnormality has occurred in the gas regeneration apparatus 50 when at least one parameter exceeds a range determined in advance in two or more excimer laser apparatuses.

### 2. Laser Gas Management System that Evaluates Abnormality of Gas Regeneration Apparatus

### 2.1 Configuration

FIG. 7 schematically shows the configurations of a laser gas management system according to a first embodiment of the present disclosure and laser apparatuses 301 to 30n connected thereto. In the first embodiment, the laser gas management system includes a laser management controller 55 in addition to the gas regeneration apparatus 50 described above. The laser gas management system further includes the laser controller 31 and the gas controller 47 provided in each of the laser apparatuses 301 to 30n.

The laser management controller 55 is connected to the regeneration controller 54 provided in the gas regeneration apparatus 50 and the laser controller 31 provided in each of the laser apparatuses 301 to 30n via signal lines. The laser management controller 55 is further connected to external apparatuses, such as a display apparatus 58 and a factory management system 59, via signal lines. The following description will be made on a case where the laser management controller 55 is provided separately from the gas regeneration apparatus 50, but not necessarily in the present disclosure. The laser management controller 55 may instead be provided in the gas regeneration apparatus 50. The laser management controller 55 may still instead be provided as part of the regeneration controller 54.

The display apparatus 58 may, for example, be an image displaying apparatus or a warning lamp. The factory management system 59 is, for example, a computer system that manages the entirety of a semiconductor factory in which the laser apparatuses 301 to 30n and the exposure apparatus 100 are installed.

2.2 Operation

The laser management controller 55 receives the result of evaluation of abnormality of any of laser performance parameters from the laser controller 31 provided in each of the laser apparatuses 301 to 30n. The laser management controller 55 evaluates abnormality of the gas regeneration apparatus 50 based on the result of evaluation of abnormality of any of laser performance parameters received from each of the laser apparatuses 301 to 30n.

When the laser management controller 55 determines that abnormality has occurred in the gas regeneration apparatus 50, the laser management controller 55 notifies the regeneration controller 54 and the laser controller 31 provided in each of the laser apparatuses 301 to 30n of the abnormality of the gas regeneration apparatus 50. When the laser management controller 55 determines that abnormality has occurred in the gas regeneration apparatus 50, the laser management controller 55 also notifies the external apparatuses, such as the display apparatus 58 and the factory management system 59, of the abnormality of the gas regeneration apparatus 50.

2.2.1 Process of Evaluating Abnormality of Gas Regeneration Apparatus

FIG. 8 is a flowchart in accordance with which the laser management controller 55 evaluates abnormality of the gas regeneration apparatus 50 in the first embodiment. The laser management controller 55 carries out the following processes to evaluate abnormality of the gas regeneration apparatus 50. In the flowcharts of the processes carried out primarily by the laser management controller 55 in the present disclosure, each step is identified by a reference character starting with “S1.”

First, in S10, the laser management controller 55 counts the number of laser apparatuses in which abnormality of a laser performance parameter has been detected. The process in S10 will be described later in detail with reference to FIG. 9. The number of laser apparatuses in which the abnormality of the laser performance parameter has been detected is counted based on an abnormality flag received from the laser controller 31 of each of the laser apparatuses. The abnormality flag setting performed by the laser controller 31 will be described later with reference to FIGS. 14 and 15.

Thereafter, in S13, the laser management controller 55 evaluates whether or not the abnormality of the laser performance parameter has been detected in two or more laser apparatuses. When the abnormality of the laser performance parameter has been detected in two or more laser apparatuses (YES in S13), the laser management controller 55 determines that abnormality has occurred in the gas regeneration apparatus 50 and proceeds to the process in S14. When the abnormality of the laser performance parameter has not been detected in two or more laser apparatuses (NO in S13), the laser management controller 55 returns to the process in S10 described above. The laser management controller 55 repeats the processes in S10 and S13 until the laser management controller 55 determines that the abnormality of the laser performance parameter has been detected in two or more laser apparatuses.

In S14, the laser management controller 55 notifies the regeneration controller 54 of the abnormality of the gas regeneration apparatus 50. Upon reception of a signal notifying the regeneration controller 54 of the abnormality of the gas regeneration apparatus 50 from the laser management controller 55, the regeneration controller 54 carries out the process in S15. In S15, the regeneration controller 54 causes the gas pressure booster 51 and the gas regenerator 52 to stop operating to terminate the gas regeneration. The regeneration controller 54 further closes the valve C-V2 and opens the valve B-V2 to stop the supply of the regenerated gas to the laser apparatuses. The new gas from the buffer gas supply source B is thus suppliable to the laser apparatuses. The valve C-V2 corresponds to the second valve in the present disclosure, and the valve B-V2 corresponds to the fourth valve in the present disclosure.

Thereafter, in S16, the laser management controller 55 notifies the laser controller 31 of each of the laser apparatuses of the abnormality of the gas regeneration apparatus 50. Upon reception of a signal notifying the laser controller 31 of each of the laser apparatuses from the laser management controller 55, the laser controller 31 carries out the process in S17. In S17, the laser controller 31 closes the valve C-V1 and opens the valve EX-V2 to stop the supply of the discharge gas to the gas regeneration apparatus 50. The valve C-V1 corresponds to the fifth valve in the present disclosure, and the valve EX-V2 corresponds to the sixth valve in the present disclosure.

Thereafter, in S18, the laser management controller 55 notifies the external apparatuses of the abnormality of the gas regeneration apparatus 50. The display apparatus 58, which is one of the external apparatuses, displays information representing the abnormality of the gas regeneration apparatus 50. The factory management system 59, which is another external apparatus, records an abnormality history of the gas regeneration apparatus 50 and notifies an operator of the factory management system 59 of the abnormality.

The laser management controller 55 then terminates the processes in the present flowchart.

2.2.1.1 Process of Counting Number of Laser Apparatuses in which Abnormality has been Detected

FIG. 9 is a flowchart showing the details of one of the processes shown in FIG. 8, the process of counting the number of laser apparatuses in which abnormality of a laser performance parameter has been detected. The processes shown in FIG. 9 are carried out as a subroutine of S10 shown in FIG. 8 by the laser management controller 55.

First, in S100, the laser management controller 55 sets the number F of laser apparatuses in which abnormality of a laser performance parameter has been detected at an initial value of 0.

Thereafter, in S101, the laser management controller 55 sets the number k of the laser apparatus in question at an initial value of 0.

Thereafter, in S102, the laser management controller 55 adds 1 to the number k of the laser apparatus in question to update the value of k.

Thereafter, in S103, the laser management controller 55 receives an abnormality flag Fk representing whether or not the abnormality of the laser performance parameter has been detected from the laser controller 31 of the numbered-k laser apparatus 30k. The abnormality flag Fk can, for example, be 0 or 1. When the abnormality of the laser performance parameter is not detected, the abnormality flag Fk has the value of 0. When the abnormality of the laser performance parameter is detected, the abnormality flag Fk has the value of 1. The abnormality flag generation process carried out by the laser controller 31 will be described later with reference to FIGS. 14 and 15.

Thereafter, in S105, the laser management controller 55 adds the value of the abnormality flag Fk to the number F of laser apparatuses in which the abnormality of the laser performance parameter has been detected to update the number F. When the value of the abnormality flag Fk is 0, the number F is not changed, and when the value of the abnormality flag Fk is 1, 1 is added to the current number F.

Thereafter, in S106, the laser management controller 55 evaluates whether or not the number k of the laser apparatus in question is greater than or equal to the number n of laser apparatuses connected to the gas regeneration apparatus 50. When the number k is greater than or equal to the number n (YES in S106), the laser management controller 55 terminates the processes in the present flowchart and returns to the processes shown in FIG. 8.

When the number k is not greater than or equal to the number n (NO in S106), the laser management controller 55 returns to the process in S102 described above. The laser management controller 55 repeats the processes from S102 to S106 until the number k becomes greater than or equal to the number n. Repeating the processes from S102 to S106 allows the abnormality flag Fk to be received from each of the numbered−1 laser apparatus to the numbered-n laser apparatus and the number of laser apparatuses in which the abnormality of the laser performance parameter has been detected to be counted.

2.2.2 Processes Carried Out by Laser Controller

The abnormality flag Fk used for the abnormality evaluation described above will next be described. The abnormality flag Fk is set by the laser controller 31 of each of the laser apparatuses based on processes that will be described later with reference to FIGS. 14 and 15. The process of setting the abnormality flag Fk is carried out based on gas-control-related data that change with time as the control of each of the laser apparatuses progresses. Processes carried out by the laser controller 31 to generate the gas-control-related data will therefore be described with reference to FIGS. 10 to 13 before the process of setting the abnormality flag Fk is described.

2.2.2.1 Energy Control

FIG. 10 is a flowchart of energy control performed by the laser controller 31 of each of the laser apparatuses in the first embodiment. The laser controller 31 carries out the following processes to control the pulse energy of the pulsed laser light generated by the laser apparatus 30k. In the flowcharts of the processes carried out by the laser controller 31 in the present disclosure, each step is identified by a reference character starting with “S2.”

First, in S210, the laser controller 31 sets charge voltage Vk provided by the charger 12 at an initial value V0. The laser controller 31 reads a pulse energy coefficient Vα from a storage device that is not shown. The pulse energy coefficient Vα is a coefficient for calculating the amount of increase or decrease in the charge voltage Vk necessary for an increase or decrease in the pulse energy by a predetermined amount. The pulse energy coefficient Vα is a positive value. The pulse energy coefficient Vα is used in S221, which will be described later.

Thereafter, in S211, the laser controller 31 reads a target pulse energy Etk from the storage device that is not shown. The target pulse energy Etk may be received from the exposure apparatus controller 110.

Thereafter, in S212, the laser controller 31 evaluates whether or not the laser apparatus 30k has achieved laser oscillation. Whether or not the laser apparatus 30k has achieved laser oscillation is evaluated, for example, by evaluating whether or not measured data has been received from the power monitor 17.

When the laser apparatus 30k has achieved laser oscillation (YES in S212), the laser controller 31 proceeds to the process in S214. When the laser apparatus 30k has not achieved laser oscillation (NO in S212), the laser controller 31 waits until the laser apparatus 30k achieves laser oscillation.

In S214, the laser controller 31 increments at least one pulse counter. The at least one pulse counter can be formed of a plurality of types of pulse counters that show the numbers of output pulses of the pulsed laser light counted with respect to a variety of points of time each as the start point. The at least one pulse counter counts the number of pulses Npgk after the partial gas replacement. The laser controller 31 adds 1 to the number of pulses Npgk after the partial gas replacement to increment the number of pulses Npgk after the partial gas replacement.

Thereafter, in S216, the laser controller 31 measures pulse energy Ek. The pulse energy Ek is calculated based on the measured data received from the power monitor 17.

Thereafter, in S220, the laser controller 31 calculates the difference ΔE between the pulse energy Ek and the target pulse energy Etk by using the following expression:

ΔE=Ek−Etk

Thereafter, in S221, the laser controller 31 updates the value of the charge voltage Vk based on the difference ΔE between the pulse energy Ek and the target pulse energy Etk by using the following expression:

Vk=Vk−Va·ΔE

For example, when the pulse energy Ek is higher than the target pulse energy Etk, the difference ΔE is a positive value. The charge voltage Vk is then lowered by subtracting the positive value indicated by Vα·ΔE from the current value of the charge voltage Vk. The pulse energy Ek can thus be so controlled as to approach the target pulse energy Etk.

Thereafter, in S222, the laser controller 31 evaluates whether or not the target pulse energy Etk has been changed. Whether or not the target pulse energy Etk has been changed is evaluated by evaluating whether or not a new target pulse energy Etk has been received from the exposure apparatus controller 110.

When the target pulse energy Etk has not been changed (NO in S222), the laser controller 31 returns to the process in S212 described above. Repeating the processes from S212 to S222 allows the laser controller 31 to change the charge voltage Vk in such a way that the pulse energy Ek approaches the target pulse energy Etk.

When the target pulse energy Etk has been changed (YES in S222), the laser controller 31 returns to the process in S211 described above. Reading a new target pulse energy Etk in S211 allows the laser controller 31 to control the pulse energy Ek based on the new target pulse energy Etk.

2.2.2.2 Gas Control

FIG. 11 is a flowchart of the gas control performed by the laser controller 31 of each of the laser apparatuses in the first embodiment. The laser controller 31 performs entire or partial gas replacement to replace the laser gas having the impurities accumulated in the chamber 10 with a laser gas having a small amount of impurities. The laser controller 31 instead performs gas pressure control to cause the charge voltage Vk necessary for the pulse energy Ek to approach the target pulse energy Etk to fall within a predetermined range.

First, in S230, the laser controller 31 sets a cumulative amount of injected gas Qk at an initial value of 0.

Thereafter, in S231, the laser controller 31 replaces the entire gas in the chamber 10. The entire gas replacement is the process of discharging the majority of the laser gas in the chamber 10 and refilling the chamber 10 with a laser gas having a small amount of impurities with outputting of the pulsed laser light from the laser apparatus 30k stopped.

Thereafter, in S232, the laser controller 31 updates the cumulative amount of injected gas Qk by using the following expression:

Qk=Qk−ΔPtg

where ΔPtg represents the amount of injected laser gas in one entire gas replacement action.

Thereafter, in S233, the laser controller 31 resets and starts a timer T1, which measures a partial gas replacement interval.

Thereafter, in S234, the laser controller 31 controls the gas pressure in the chamber 10. For example, injecting the laser gas into the chamber 10 to increase the chamber gas pressure allows a decrease in the charge voltage Vk necessary for the pulse energy Ek to approach the target pulse energy Etk. The gas pressure control will be described later in detail with reference to FIG. 12. When the laser gas is injected into the chamber 10 in the gas pressure control, the cumulative amount of injected gas Qk is updated, as will be described later.

Thereafter, in S235, the laser controller 31 evaluates whether or not the charge voltage Vk is lower than a maximum voltage Vmax2. When the impurities accumulate in the chamber 10, the performance of the laser apparatus 30k decreases, resulting in an increase in the charge voltage Vk necessary for the pulse energy Ek to approach the target pulse energy Etk. When the gas pressure control in S234 increases the charge voltage Vk to a value greater than or equal to the maximum voltage Vmax2, which is the upper limit of the adjustable range (NO in S235), the laser controller 31 returns to the process in S231 described above, where the laser controller 31 performs the entire gas replacement. When the charge voltage Vk is lower than the maximum voltage Vmax 2, the laser controller 31 proceeds to the process in S236.

In S236, the laser controller 31 compares the value of the timer T1 with a partial gas replacement cycle Tpg. When the value of the timer T1 is greater than or equal to the partial gas replacement cycle Tpg (YES in S236), the laser controller 31 proceeds to the process in S237. When the value of the timer T1 is smaller than the partial gas replacement cycle Tpg (NO in S236), the laser controller 31 returns to the process in S234 described above. The laser controller 31 repeats the processes from S234 to S236 until the charge voltage Vk becomes higher than or equal to the maximum voltage Vmax 2 or the value of the timer T1 is greater than or equal to the partial gas replacement cycle Tpg.

In S237, the laser controller 31 partially replaces the gas in the chamber 10. The partial gas replacement is the process of discharging only part of the laser gas in the chamber 10 and replenishing a laser gas having a small amount of impurities by the same amount of the discharged laser gas with outputting of the pulsed laser light from the laser apparatus 30k allowed. The partial gas replacement will be described later in detail with reference to FIG. 13.

Thereafter, in S238, the laser controller 31 updates the cumulative amount of injected gas Qk by using the following expression:

Qk=Qk−ΔPpg

where ΔPpg represents the amount of partially replaced gas, which will be described later. The amount of partially replaced gas ΔPpg corresponds to the amount of injected gas in one partial gas replacement action.

After S238, the laser controller 31 returns to the process in S233 described above and resets and starts the timer T1, which measures the partial gas replacement interval. The laser controller 31 repeats the processes from S233 to S238 until the charge voltage Vk becomes greater than or equal to the maximum voltage Vmax2.

FIG. 12 is a flowchart showing the details of the gas pressure control shown in FIG. 11. The processes shown in FIG. 12 are carried out as a subroutine of S234 shown in FIG. 11 by the laser controller 31.

First, in S2340, the laser controller 31 reads a first threshold Vmin and a second threshold Vmax of the charge voltage and an increase/decrease width ΔP of the chamber gas pressure from the storage device that is not shown. The first threshold Vmin is smaller than the second threshold Vmax. The second threshold Vmax is a value smaller than the maximum voltage Vmax2 described with reference to FIG. 11.

Thereafter, in S2341, the laser controller 31 measures a chamber gas pressure PLk. The chamber gas pressure PLk is calculated based on the measured data received from the chamber pressure sensor P1.

Thereafter, in S2342, the laser controller 31 reads the charge voltage Vk. The charge voltage Vk is charge voltage contained in the setting signal transmitted from the laser controller 31 to the charger 12.

Thereafter, in S2343, the laser controller 31 compares the charge voltage Vk with the two thresholds Vmin and Vmax. The following three results of the comparison are conceivable:

(1) The charge voltage Vk is greater than the second threshold Vmax (Vk>Vmax);

(2) The charge voltage Vk is greater than or equal to the first threshold Vmin but smaller than or equal to the second threshold Vmax (Vmax≥Vk≥Vmin); and

(3) The charge voltage Vk is smaller than the first threshold Vmin (Vmin>Vk).

(1) When the charge voltage Vk is greater than the second threshold Vmax (Vk>Vmax), the laser controller 31 proceeds to the process in S2344.

In S2344, the laser controller 31 injects the buffer gas into the chamber 10 in such a way that the chamber gas pressure PLk increases by ΔP. The buffer gas is injected in response to transmission of a signal that requests opening or closing of the valve B-V1 to the gas controller 47. Injecting the buffer gas into the chamber 10 to raise the chamber gas pressure PLk allows a decrease in the charge voltage Vk necessary for the pulse energy Ek to approach the target pulse energy Etk.

Thereafter, in S2345, the laser controller 31 updates the cumulative amount of injected gas Qk by using the following expression:

Qk=Qk+ΔP

After S2345, the laser controller 31 terminates the processes in the present flowchart and returns to the processes in FIG. 11.

(2) When the charge voltage Vk is greater than or equal to the first threshold Vmin but smaller than or equal to the second threshold Vmax (Vmax≥Vk≥Vmin), the laser controller 31 terminates the processes in the present flowchart and returns to the processes in FIG. 11.

(3) When the charge voltage Vk is smaller than the first threshold Vmin (Vmin>Vk), the laser controller 31 proceeds to the process in S2346.

In S2346, the laser controller 31 discharges the laser gas in the chamber 10 in such a way that the chamber gas pressure PLk decreases by ΔP. The laser gas is discharged in response to transmission of a signal that requests opening or closing of the valve EX-V1 to the gas controller 47. Discharging the laser gas in the chamber 10 to lower the chamber gas pressure PLk allows an increase in the charge voltage Vk necessary for the pulse energy Ek to approach the target pulse energy Etk.

After S2346, the laser controller 31 terminates the processes in the present flowchart and returns to the processes in FIG. 11.

FIG. 13 is a flowchart showing the details of the partial gas replacement shown in FIG. 11. The processes shown in FIG. 13 are carried out as a subroutine of S237 shown in FIG. 11 by the laser controller 31.

First, in S2370, the laser controller 31 reads the number of pulses Npgk after the partial gas replacement. The number of pulses Npgk after the partial gas replacement may be the number counted in S214 in FIG. 10.

Thereafter, in S2371, the laser controller 31 calculates the amount of injected buffer gas ΔPbg by using the following expression:

ΔPbg=Kbg·Npgk

where Kbg represents a coefficient for calculating the amount of injected buffer gas ΔPbg in accordance with the number of pulses Npgk after the partial gas replacement.

Thereafter, in S2372, the laser controller 31 injects the buffer gas into the chamber 10 in such a way that the chamber gas pressure PLk increases by ΔPbg.

Thereafter, in S2373, the laser controller 31 calculates the amount of injected fluorine-containing gas ΔPhg by using the following expression:

ΔPhg=Khg·Npgk

where Khg represents a coefficient for calculating the amount of injected fluorine-containing gas ΔPhg in accordance with the number of pulses Npgk after the partial gas replacement.

Thereafter, in S2374, the laser controller 31 injects the fluorine-containing gas into the chamber 10 in such a way that the chamber gas pressure PLk increases by ΔPhg.

Thereafter, in S2375, the laser controller 31 calculates the amount of partially replaced gas ΔPpg by using the following expression:

ΔPpg=ΔPbg+ΔPhg

The amount of partially replaced gas ΔPpg is the sum of the amount of injected buffer gas ΔPbg and the amount of injected fluorine-containing gas ΔPhg. Data on the amount of partially replaced gas ΔPpg is used to update the cumulative amount of injected gas Qk in S238 in FIG. 11.

Thereafter, in S2376, the laser controller 31 discharges the laser gas in the chamber 10 in such a way that the chamber gas pressure PLk decreases by ΔPpg.

After S2376, the laser controller 31 terminates the processes in the present flowchart and returns to the processes in FIG. 11.

Carrying out the processes in FIGS. 10 to 13 described above generates the following gas-control-related data for setting the abnormality flag Fk:

(1) Charge voltage Vk set in S221 in FIG. 10;

(2) Chamber gas pressure PLk measured in S2341 in FIG. 12;

(3) Cumulative amount of injected gas Qk calculated in S232 and S238 in FIG. 11 and S2345 in FIG. 12; and

(4) Pulse energy Ek measured in S216 in FIG. 10.

2.2.3 Process of Setting Abnormality Flag Fk

FIG. 14 is a flowchart in accordance with which the laser controller 31 of each of the laser apparatuses sets the abnormality flag Fk in the first embodiment. The laser controller 31 carries out the processes below to set the abnormality flag Fk.

First, in S2040, the laser controller 31 measures and calculates a variety of laser performance parameters based on the gas-control-related data. S2040 will be described later in detail with reference to FIG. 15. The laser performance parameters calculated in S2040 include the following parameters:

(1) Amount of change in charge voltage ΔVk;

(2) Amount of change in chamber gas pressure ΔPLk;

(3) Amount of gas consumption ΔQk; and

(4) Pulse energy stability Eσk.

When the amount of impurities contained in the laser gas increases, the values of the laser performance parameters are likely to increase. When the values of the laser performance parameters increase in a plurality of the laser apparatuses, abnormality is likely to occur in the gas regeneration apparatus 50, which supplies the regenerated gas.

Thereafter, in S2042, the laser controller 31 evaluates whether or not any of the laser performance parameters exceeds a range determined in advance. For example, the laser controller 31 evaluates whether or not any of the laser performance parameters is greater than or equal to a threshold for abnormality evaluation. Specifically, the laser controller 31 evaluates whether or not any of the following conditions is satisfied:

ΔVk≥ΔVmax; (1)

ΔPLk≥ΔPLmax; (2)

ΔQk≥ΔQmax; and (3)

Eσk≥Eσmax, (4)

where ΔVmax, ΔPLmax, ΔQmax, and Eσmax are each a threshold for evaluation of abnormality of the corresponding laser performance parameter.

When the laser performance parameters are each not greater than or equal to the corresponding threshold for abnormality evaluation (NO in S2042), the laser controller 31 proceeds to the process in S2046.

In S2046, the laser controller 31 sets the abnormality flag Fk at a value representing that no abnormality has occurred. The value representing that no abnormality has occurred is, for example, 0.

After S2046, the laser controller 31 proceeds to the process in S2049.

When any of the laser performance parameters is greater than or equal to the corresponding threshold for abnormality evaluation (YES in S2042), the laser controller 31 proceeds to the process in S2047.

In S2047, the laser controller 31 sets the abnormality flag Fk at a value representing that abnormality has occurred. The value representing that abnormality has occurred is, for example, 1.

After S2047, the laser controller 31 proceeds to the process in S2049.

In S2049, the laser controller 31 transmits the value of the abnormality flag Fk to the laser management controller 55. The abnormality flag Fk is used to evaluate abnormality of the gas regeneration apparatus 50 described with reference to FIGS. 8 and 9.

2.2.3.1 Measurement and Calculation of Laser Performance Parameters

FIG. 15 is a flowchart showing the details of the measurement and calculation of the laser performance parameters shown in FIG. 14. The processes shown in FIG. 15 are carried out as a subroutine of S2040 shown in FIG. 14 by the laser controller 31.

First, in S2040a, the laser controller 31 sets a pulse counter Nes at an initial value of 0. The pulse counter Nes is a counter configured to measure a laser performance parameter calculation interval. Carrying out the following processes allows the laser performance parameters to be calculated whenever the value of the pulse counter Nes reaches Nesmax.

Thereafter, in S2040b, the laser controller 31 evaluates whether or not the laser apparatus 30k has achieved laser oscillation. Whether or not the laser apparatus 30k has achieved laser oscillation is evaluated, for example, by evaluating whether or not the measured data has been received from the power monitor 17.

When the laser apparatus 30k has achieved laser oscillation (YES in S2040b), the laser controller 31 proceeds to the process in S2040c. When the laser apparatus 30k has not achieved laser oscillation (NO in S2040b), the laser controller 31 waits until the laser apparatus 30k achieves laser oscillation.

In S2040c, the laser controller 31 adds 1 to the current value of the pulse counter Nes to increment the pulse counter Nes.

Thereafter, in S2040d, the laser controller 31 reads the pulse energy Ek measured in S216 in FIG. 10. The laser controller 31 associates the value of the read pulse energy Ek with the current value of the pulse counter Nes and stores the resultant pulse energy Ek as pulse energy Enes in the storage device that is not shown.

Thereafter, in S2040e, the laser controller 31 evaluates the value of the pulse counter Nes. The result of the evaluation of the value of the pulse counter Nes includes the following three:

Nes=1; (1)

1<Nes<Nesmax; and (2)

Nex≥Nesmax. (3)

Nes=1 (1)

When the value of the pulse counter Nes is 1, the laser controller 31 proceeds to the process in S2040f. In S2040f, the laser controller 31 reads the current charge voltage Vk, chamber gas pressure PLk, and cumulative amount of injected gas Qk and stores the read values as initial values V0, PL0, and Q0 in the storage device that is not shown as follows:

V0=Vk;

PL0=PLk; and

Q0=Qk.

1<Nes<Nesmax (2)

When the value of the pulse counter Nes is greater than 1 but smaller than Nesmax, the laser controller 31 returns to the process in S2040b described above. Repeating the processes in S2040b to S2040e until the value of the pulse counter Nes becomes greater than or equal to Nesmax allows accumulation of time-series data on the pulse energy Enes.

Nes≥Nesmax (3)

When the value of the pulse counter Nes is greater than or equal to Nesmax, the laser controller 31 proceeds to the process in S2040g. In S2040g, the laser controller 31 reads the current charge voltage Vk, chamber gas pressure PLk, and cumulative amount of injected gas Qk and stores the read values as final values Vesmax, PLesmax, and Qesmax in the storage device that is not shown as follows:

Vesmax=Vk;

PLesmax=PLk; and

Qesmax=Qk.

Thereafter, in S2040h, the laser controller 31 calculates a standard deviation 6 and an average Eav of the pulse energy Enes based on the time-series data on the pulse energy Enes from the time when the pulse counter Nes is 1 to the time when the pulse counter Nes is Nesmax. The laser controller 31 calculates the pulse energy stability Eσk based on the standard deviation σ and the average Eav of the pulse energy Enes by using the following expression:

Eσk=σ/Eav

In the above expression, the denominator is the average Eav, and Eav may be replaced with the target pulse energy Etk in the calculation.

Thereafter, in S2040i, the laser controller 31 calculates the amount of change in charge voltage ΔVk, the amount of change in chamber gas pressure ΔPLk, and the amount of gas consumption ΔQk by using the expressions below:

ΔVk=Vesmax−V0;

ΔPLk=Plesmax−PL0; and

ΔQk=Qexmax−Q0.

After S2040i, the laser controller terminates the processes in the present flowchart and returns to the processes in FIG. 14.

The laser controller evaluates abnormality of the gas regeneration apparatus 50 based on the thus calculated laser performance parameters.

2.3 Effects

In the first embodiment, it is evaluated for each of the laser apparatuses 301 to 30n whether or not at least one of the laser performance parameters exceeds a range determined in advance. When at least one of the laser performance parameters exceeds a range determined in advance in two or more excimer laser apparatuses, it is determined that abnormality has occurred in the gas regeneration apparatus 50. Abnormality of the gas regeneration apparatus 50 can thus be evaluated.

When it is determined that abnormality has occurred in the gas regeneration apparatus 50, the process of supplying each of the laser apparatuses with the regenerated gas is discontinued, and the new gas is allowed to be supplied to each of the laser apparatuses. Therefore, even when a problem occurs in the gas regeneration apparatus 50, a situation in which the plurality of laser apparatuses simultaneously stop operating can be suppressed.

Further, according to the first embodiment, abnormality of the gas regeneration apparatus 50 can be detected with no use of a component analyzer that detects the concentrations of the impurities in the regenerated gas. The cost of the gas regeneration apparatus 50 and the space where the gas regeneration apparatus 50 is installed are therefore reduced, as compared with the case where a component analyzer is used.

### 3. Case where Laser Management Controller Sets Abnormality Flag

3.1 Configuration

FIG. 16 schematically shows the configurations of a laser gas management system according to a second embodiment of the present disclosure and laser apparatuses 301 to 30n connected thereto. In the second embodiment, the laser management controller 55 includes an analyzer 56 and a storage 57. The storage 57 is configured to store the gas-control-related data received from the plurality of laser apparatuses 301 to 30n. The analyzer 56 is configured to calculate the laser performance parameters of the laser apparatuses and sets the abnormality flag for each of the laser apparatuses based on the gas-control-related data.

The other points are the same as those in the first embodiment.

3.2 Operation

The process in which the laser management controller 55 evaluates abnormality of the gas regeneration apparatus 50 in the second embodiment is the same as the process in the first embodiment described with reference to FIG. 8.

3.2.1 Process of Counting Number of Laser Apparatuses in which Abnormality has been Detected

FIG. 17 is a flowchart showing the details of the process in which the laser management controller 55 counts the number of laser apparatuses in which abnormality of a laser performance parameter has been detected in the second embodiment. The processes shown in FIG. 17 are carried out as a subroutine of S10 shown in FIG. 8 by the analyzer 56 of the laser management controller 55. It is assumed in the description of the present disclosure that the processes carried out by the analyzer 56 of the laser management controller 55 are carried out by the laser management controller 55 for ease of description.

Out of the processes shown in FIG. 17, the processes in S100, S101, S102, S105, and 5106 are the same as those in the first embodiment described with reference to FIG. 9. The first and second embodiments differ from each other in that the process in S103 in FIG. 9 is replaced with the process in S104 in FIG. 17. In S103 in FIG. 9, the laser management controller 55 receives the abnormality flag Fk from the numbered-k laser apparatus 30k, whereas in S104 in FIG. 17, the laser management controller 55 sets the abnormality flag Fk of the numbered-k laser apparatus 30k. The process in S104 will be described later in detail with reference to FIG. 18.

3.2.2 Process of Setting Abnormality Flag Fk

FIG. 18 is a flowchart of the process in which the laser management controller 55 sets the abnormality flag Fk in the second embodiment. The processes shown in FIG. 18 are carried out as a subroutine of S104 shown in FIG. 17 by the laser management controller 55.

As a prerequisite of the processes shown in FIG. 18, the laser management controller 55 calculates the variety of laser performance parameters. The calculation of the laser performance parameters will be described later with reference to FIGS. 21 to 25. The laser performance parameters calculated by the laser management controller 55 include the following parameters:

(1) Amount of change in charge voltage ΔVsk per predetermined number of pulses ΔN;

(2) Amount of change in chamber gas pressure ΔPLsk per predetermined number of pulses ΔN;

(3) Amount of gas consumption ΔQsk per predetermined number of pulses ΔN; and

(4) Pulse energy stability Eσk.

In S1043 in FIG. 18, the laser management controller 55 evaluates whether or not any of the laser performance parameters exceeds a range determined in advance. For example, the laser management controller 55 evaluates whether or not any of the laser performance parameters is greater than or equal to a threshold for abnormality evaluation. Specifically, the laser management controller 55 evaluates whether or not any of the following conditions is satisfied:

ΔVsk≥ΔVsmax; (1)

ΔPLsk≥ΔPLsmax; (2)

ΔQsk≥ΔQsmax; and (3)

Eσk≥Eσmax, (4)

where ΔVsmax, ΔPsLmax, ΔQsmax, and Eσmax are each a threshold for evaluation of abnormality of the corresponding laser performance parameter.

When the laser performance parameters are each not greater than or equal to the corresponding threshold for abnormality evaluation (NO in S1043), the laser management controller 55 proceeds to the process in S1046.

In S1046, the laser management controller 55 sets the abnormality flag Fk of the numbered-k laser apparatus 30k at a value representing that no abnormality has occurred. The value representing that no abnormality has occurred is, for example, 0.

After S1046, the laser management controller 55 terminates the processes in the present flowchart and returns to the processes shown in FIG. 17.

When the laser performance parameters are each greater than or equal to the corresponding threshold for abnormality evaluation (YES in S1043), the laser management controller 55 proceeds to the process in S1047.

In S1047, the laser management controller 55 sets the abnormality flag Fk of the numbered-k laser apparatus 30k at a value representing that abnormality has occurred. The value representing that abnormality has occurred is, for example, 1.

Thereafter, in S1048, the laser management controller 55 causes the storage 57 to store a laser performance parameter greater than or equal to the corresponding threshold for abnormality evaluation.

After S1048, the laser management controller 55 terminates the processes in the present flowchart and returns to the processes shown in FIG. 17.

3.2.3 Processes Carried Out by Laser Controller

Laser performance parameters used to set the abnormality flag described above will next be described. The laser performance parameters are calculated by the laser management controller 55 that carries out the processes that will be described later with reference to FIGS. 21 to 25. The laser performance parameters are calculated based on the gas-control-related data that change with time as the control of each of the laser apparatuses progresses. Processes carried out by the laser controller 31 to generate the gas-control-related data will therefore be described with reference to FIGS. 19, 20A, and 20B before the process of calculating the laser performance parameters is described.

FIG. 19 is a flowchart of energy control performed by the laser controller 31 of each of the laser apparatuses in the second embodiment. Out of the processes shown in FIG. 19, the processes in S210, S211, S212, S216, S220, S221, and S222 are the same as those in the first embodiment described with reference to FIG. 10. The first and second embodiments differ from each other in that the process in S214 in FIG. 10 is replaced with the process in S215 in FIG. 19 and the processes in S217 and S218 are carried out between S216 and S220.

In S215, the laser controller 31 increments at least one pulse counter. The at least one pulse counter can be formed of a plurality of types of pulse counters that show the numbers of output pulses of the pulsed laser light counted with respect to a variety of points of time each as the start point. The at least one pulse counter can count the following pulses:

Total number of in-laser-apparatus pulses Nlak;

Number of pulses Nchk in chamber;

Number of pulses Ntgk after entire gas replacement; and

Number of pulses Npgk after partial gas replacement.

In S217, the laser controller 31 measures the chamber gas pressure PLk. The chamber gas pressure PLk is calculated based on the measured data received from the chamber pressure sensor P1. The laser controller 31 may instead measure the chamber gas pressure PLk in the gas pressure control described with reference to FIG. 12.

In S218, the laser controller 31 transmits the following gas-control-related data to the laser management controller 55:

Total number of in-laser-apparatus pulses Nlak;

Number of pulses Nchk in chamber;

Number of pulses Ntgk after entire gas replacement;

Number of pulses Npgk after partial gas replacement;

Target pulse energy Etk;

Pulse energy Ek;

Charge voltage Vk;

Chamber gas pressure PLk;

Point of time Time; and

Cumulative amount of injected gas Qk.

Out of the gas-control-related data described above, the point of time Time is the current time measured by the laser controller 31. The cumulative amount of injected gas Qk is calculated in the gas pressure control described with reference to FIGS. 11 and 12.

The gas-control-related data transmitted to the laser management controller 55 are stored in the storage 57 of the laser management controller 55.

FIGS. 20A and 20B show an example of the gas-control-related data stored in the storage 57 of the laser management controller 55 in the second embodiment. The gas-control-related data are stored, for example, in the form of a table, such as that shown in FIGS. 20A and 20B. FIGS. 20A and 20B show one data table, although separated into two for convenience of the space. The gas-control-related data contain a plurality of records. The plurality of records include records numbered from 1 to N+1.

The plurality of records contain the following gas-control-related data:

Total number of in-laser-apparatus pulses Nlak;

Number of pulses Nchk in chamber;

Number of pulses Ntgk after entire gas replacement;

Number of pulses Npgk after partial gas replacement;

Target pulse energy Etk;

Pulse energy Ek;

Charge voltage Vk;

Chamber gas pressure PLk;

Point of time Time; and

Cumulative amount of injected gas Qk.

The gas-control-related data are measured whenever the predetermined number of pulses ΔN are counted. One new record is added to the gas-control-related data whenever the predetermined number of pulses ΔN are counted. In the case that follows the processes shown in FIG. 19, the predetermined number of pulses ΔN is 1.

FIGS. 20A and 20B show the gas-control-related data from the numbered-k laser apparatus. The storage 57 stores n sets of gas-control-related data as the gas-control-related data from the plurality of laser apparatuses 301 to 30n.

3.2.4 Calculation of Laser Performance Parameters

FIG. 21 is a flowchart in accordance with which the laser management controller 55 calculates the laser performance parameters in the second embodiment. The laser management controller 55 carries out the following processes to calculate the laser performance parameters based on the gas-control-related data shown in FIGS. 20A and 20B.

First, in S1900, the laser management controller 55 sets the number k of the laser apparatus in question at an initial value of 0.

Thereafter, in S1901, the laser management controller 55 adds 1 to the number k of the laser apparatus in question to update the value k.

Thereafter, in S1902, the laser management controller 55 reads from the storage 57 the gas-control-related data from the numbered-k laser apparatus 30k at a point of time Time(a). Specifically, the laser management controller 55 identifies the records corresponding to the point of time Time(a) in the table shown in FIGS. 20A and 20B and reads the gas-control-related data from the identified records.

The process in S1902 will be described later in detail with reference to FIG. 22.

Thereafter, in S1903, the laser management controller 55 calculates a point of time Time(b), which is a point of time later than the point of time Time(a) by a predetermined period Δt, by using the following expression:

Time(b)=Time(a)+Δt

Thereafter, in S1904, the laser management controller 55 reads from the storage 57 the gas-control-related data from the numbered-k laser apparatus 30k at the point of time Time(b). Specifically, the laser management controller 55 identifies the records corresponding to the point of time Time(b) in the table shown in FIGS. 20A and 20B and reads the gas-control-related data from the identified records.

The process in S1904 will be described later in detail with reference to FIG. 23.

Thereafter, in S1905, the laser management controller 55 calculates the laser performance parameters of the numbered-k laser apparatus 30k per predetermined number of pulses ΔN based on the gas-control-related data at the points of time Time(a) and Time(b). The laser performance parameters per predetermined number of pulses ΔN contain the following laser performance parameters:

(1) Amount of change in charge voltage ΔVsk per predetermined number of pulses ΔN;

(2) Amount of change in chamber gas pressure ΔPLsk per predetermined number of pulses ΔN; and

(3) Amount of gas consumption ΔQsk per predetermined number of pulses ΔN.

The process in S1905 will be described later in detail with reference to FIG. 24.

Thereafter, in S1906, the laser management controller 55 calculates the following laser performance parameter of the numbered-k laser apparatus 30k based on the gas-control-related data between the points of time Time(a) and Time(b).

(4) Pulse energy stability Eσk

The process in S1906 will be described later in detail with reference to FIG. 25.

Thereafter, in S1908, the laser management controller 55 evaluates whether or not the number k of the laser apparatus in question is greater than or equal to the number n of the laser apparatuses connected to the gas regeneration apparatus 50. When the number k is greater than or equal to the number n (YES in S1908), the laser management controller 55 proceeds to the process in S1909.

When the number k is not greater than or equal to the number n (NO in S1908), the laser management controller 55 returns to the process in S1901 described above. The laser management controller 55 repeats the processes from S1901 to S1908 until the number k becomes greater than or equal to the number n. Repeating the processes from S1901 to S1908 allows the laser performance parameters to be calculated for each of the numbered−1 laser apparatus to the numbered-n laser apparatus.

In S1909, the laser management controller 55 updates the point of time Time(a) by using the following expression:

Time(a)=Time(b)

The point of time Time(b), which is the result of the addition of the predetermined period Δt to the original point of time Time(a), is changed to a new point of time Time(a).

Thereafter, in S1910, the laser management controller 55 evaluates whether or not the calculation of the laser performance parameters is discontinued. When the calculation of the laser performance parameters is discontinued (YES in S1910), the laser management controller 55 terminates the processes in the present flowchart. When the calculation of the laser performance parameters is not discontinued (NO in S1910), the laser management controller 55 returns to the process in S1900 described above and uses the point of time Time(a) newly set in S1909 to calculate the laser performance parameters.

FIG. 22 is a flowchart showing the details of the gas-control-related data reading process at the point of time Time(a) shown in FIG. 21. The processes shown in FIG. 22 are carried out as a subroutine of S1902 shown in FIG. 21 by the laser management controller 55.

In S1902a, the laser management controller 55 reads the following gas-control-related data from the storage 57:

Total number of pulses Nlak(a) in numbered-k laser apparatus 30k at point of time Time(a);

Charge voltage Vk(a) in numbered-k laser apparatus 30k at point of time Time(a);

Chamber gas pressure PLk(a) in numbered-k laser apparatus 30k at point of time Time(a); and

Cumulative amount of injected gas Qk(a) in numbered-k laser apparatus 30k at point of time Time(a).

After S1902a, the laser management controller 55 terminates the processes in the present flowchart and returns to the process shown in FIG. 21.

FIG. 23 is a flowchart showing the details of the gas-control-related data reading process at the point of time Time(B) shown in FIG. 21. The processes shown in FIG. 23 are carried out as a subroutine of S1904 shown in FIG. 21 by the laser management controller 55.

In S1904a, the laser management controller 55 reads the following gas-control-related data from the storage 57:

Total number of pulses Nlak(b) in numbered-k laser apparatus 30k at point of time Time(b);

Charge voltage Vk(b) in numbered-k laser apparatus 30k at point of time Time(b);

Chamber gas pressure PLk(b) in numbered-k laser apparatus 30k at point of time Time(b); and

Cumulative amount of injected gas Qk(b) in numbered-k laser apparatus 30k at point of time Time(b).

After S1904a, the laser management controller 55 terminates the processes in the present flowchart and returns to the process shown in FIG. 21.

FIG. 24 is a flowchart showing the details of the process of calculating the laser performance parameters per predetermined number of pulses ΔN shown in FIG. 21. The processes shown in FIG. 24 are carried out as a subroutine of S1905 shown in FIG. 21 by the laser management controller 55.

First, in S1905a, the laser management controller 55 calculates the number of pulses S between the points of time Time(a) and Time(b) by using the following expression:

S=Nlak(b)−Nlak(a)

Thereafter, in S1905b, the laser management controller 55 calculates the amount of change in charge voltage ΔVsk per predetermined number of pulses ΔN, the amount of change in chamber gas pressure ΔPLsk per predetermined number of pulses ΔN, and the amount of gas consumption ΔQsk per predetermined number of pulses ΔN by using the expressions below.

ΔVsk=(Vk(b)−Vk(a))/S;

ΔPLsK=(PLk(b)−PLk(a))/S; and

ΔQsk=(Qk(b)−Qk(a))/S.

After S1905b, the laser management controller 55 terminates the processes in the present flowchart and returns to the process shown in FIG. 21.

FIG. 25 is a flowchart showing the details of the pulse energy stability calculating process shown in FIG. 21. The processes shown in FIG. 25 are carried out as a subroutine of S1906 shown in FIG. 21 by the laser management controller 55.

First, in S1906a, the laser management controller 55 reads time-series data on the pulse energy Ek between the points of time Time(a) and Time(b). For example, let Time(1) be the point of time Time(a) and Time(4) be the point of time Time(b), and the time-series data on the pulse energy Ek include Ek(1), Ek(2), and Ek(3).

Thereafter, in S1906b, the laser management controller 55 calculates the standard deviation 6 and the average Eav of the pulse energy Ek based on the time-series data on the pulse energy Ek between the points of time Time(a) and Time(b). The laser controller 31 calculates the pulse energy stability Eσk based on the standard deviation 6 and the average Eav of the pulse energy Ek by using the following expression:

Eσk=σ/Eav

In the above expression, the denominator is the average Eav, and Eav may be replaced with the target pulse energy Etk in the calculation.

After S1906b, the laser management controller 55 terminates the processes in the present flowchart and returns to the processes shown in FIG. 21.

The laser performance parameters calculated by carrying out the processes in FIGS. 21 to 25 are used to set the abnormality flag Fk in FIGS. 17 and 18.

3.2.5 Evaluation of Abnormality of Gas Regeneration Apparatus Based on Laser Performance Parameters

FIG. 26 is a table showing an example of evaluation of abnormality of the gas regeneration apparatus 50 based on the laser performance parameters in the second embodiment. The laser performance parameters are calculated for each of the numbered−1 laser apparatus 301 to the numbered-n laser apparatus 30n. Further, one set of laser performance parameters are calculated whenever the predetermined period Δt described with reference to FIG. 21 elapses.

In S1043 in FIG. 18, it is evaluated whether or not the laser performance parameters are each greater than or equal to the corresponding threshold for abnormality evaluation. A laser performance parameter determined to be greater than or equal to the corresponding threshold for abnormality evaluation is hatched in FIG. 26.

For example, at the point of time Time(a)+Δt, the amount of change in charge voltage ΔVs1[1] of the numbered−1 laser apparatus 301 per predetermined number of pulses ΔN is determined to be greater than or equal to the corresponding threshold for abnormality evaluation. The abnormality flag Fk of the numbered−1 laser apparatus 301 at the point of time Time(a)+Δt is 1 based on the processes shown in FIG. 18. When the abnormality flag Fk is 1 in one laser apparatus, F=1 is provided based on the processes shown in FIG. 17. That is, it is determined that no abnormality has occurred in the gas regeneration apparatus 50 based on the processes shown in FIG. 8. The evaluation is performed whenever the predetermined period Δt elapses, as shown in FIG. 26. The term “OK” shown in the field “Evaluation” in FIG. 26 represents that no abnormality has occurred in the gas regeneration apparatus 50.

Further, for example, at the point of time Time(a)+4Δt, the amount of change in charge voltage ΔVs1[4] of the numbered−1 laser apparatus 301 per predetermined number of pulses ΔN and the amount of change in chamber gas pressure ΔPLs2[4] of the numbered−2 laser apparatus 302 per predetermined number of pulses ΔN are each determined to be greater than or equal to the corresponding threshold for abnormality evaluation. The abnormality flag Fk of each of the numbered−1 laser apparatus 301 and the numbered−2 laser apparatus 302 at the point of time Time(a)+4Δt is 1 based on the processes shown in FIG. 18. When the abnormality flag Fk is 1 in two laser apparatuses, F=2 is provided based on the processes shown in FIG. 17. That is, it is determined that abnormality has occurred in the gas regeneration apparatus 50 based on the processes shown in FIG. 8. The term “NG” shown in the field “Evaluation” in FIG. 26 represents that abnormality has occurred in the gas regeneration apparatus 50.

The laser management controller 55 may cause the storage 57 to store the transition of the laser performance parameters shown in FIG. 26. The laser management controller 55 may transmit the transition of the laser performance parameters shown in FIG. 26 to the factory management system 59. The factory management system 59 may cause the display apparatus 58 to display the transition of the laser performance parameters shown in FIG. 26. Instead, only a laser performance parameter greater than or equal to the corresponding threshold for abnormality evaluation may be stored in the storage 57, as described with reference to FIG. 18.

### 4. Case where Threshold for Abnormality Evaluation is Calculated in Accordance with Number of Pulses in Chamber

### 4.1 Overview

FIG. 27 shows graphs illustrating a change in a laser performance parameter taken into consideration for the calculation of the threshold for evaluation of abnormality of the laser performance parameter in a third embodiment of the present disclosure. The horizontal axis of FIG. 27 represents the number of in-chamber pulses Nchk, and the vertical axis of FIG. 27 represents an arbitrary laser performance parameter. The laser performance parameter changes due not only to abnormality of the gas regeneration apparatus 50 but to the state of the chamber 10.

When the number of in-chamber pulses Nchk is small, the laser performance parameter starts with a large value and gradually settles at a small value in some cases, as shown in FIG. 27. The reason for this is that when the chamber 10 is a brand-new chamber, the step called “passivation” is carried out. When the chamber 10 is a brand-new chamber, the surface of a part in the chamber 10 reacts with a halogen gas contained in the laser gas to generate impurities by an amount larger than in a normal situation. When a coating is formed as a result of the reaction between the surface of the part in the chamber 10 and the halogen gas, a chemically equilibrium state and a passive state are achieved. The generation of the impurities is thus suppressed, and the laser performance parameter settles at a small value. The step described above is called “passivation.”

The part in the chamber 10 deteriorates as the number of in-chamber pulses Nchk increases. Therefore, after the passivation is completed, the laser performance parameter increases as the number of in-chamber pulses Nchk increases. Specifically, consumption of the discharge electrodes 11a and 11b due to the discharge reduces the pulse energy of the outputted pulsed laser light in accordance with the number of in-chamber pulses even when the same fed energy is inputted irrespective of the impurities in the laser chamber. As a result, the laser performance parameter increases. The chamber 10 eventually reaches its lifetime.

As described above, the laser performance parameter changes in accordance with the state of the chamber 10. Therefore, a change in the laser performance parameter does not necessarily result from abnormality of the gas regeneration apparatus 50 and may result from a change in the state of the chamber 10. The state of the chamber 10 tends to change along with a change in the number of in-chamber pulses Nchk as shown in FIG. 27. In view of the fact described above, the threshold for the evaluation of abnormality of a laser performance parameter is calculated in accordance with the number of in-chamber pulses Nchk in the third embodiment. The effect of a change in the state of the chamber 10 on the evaluation of abnormality of the gas regeneration apparatus 50 is thus reduced.

The threshold for the evaluation of abnormality of a laser performance parameter is calculated, for example, as follows: The laser performance parameter is measured whenever the number of in-chamber pulses Nchk is counted for each of a large number of laser apparatuses; and the standard deviation of the measured values of the laser performance parameter is added to the average thereof whenever the number of in-chamber pulses Nchk is counted to calculate the threshold for the evaluation of abnormality of the laser performance parameter.

The configurations of the laser gas management system and the laser apparatuses in the third embodiment are the same as those in the second embodiment described with reference to FIG. 16.

4.2 Operation

The process in which the laser management controller 55 evaluates abnormality of the gas regeneration apparatus 50 in the third embodiment is the same as the process in the first embodiment described with reference to FIG. 8.

The process in which the laser management controller 55 counts the number of laser apparatuses in which abnormality of a laser performance parameter has been detected in the third embodiment is the same as the process in the second embodiment described with reference to FIG. 17.

4.2.1 Process of Setting Abnormality Flag Fk

FIG. 28 is a flowchart in accordance with which the laser management controller 55 sets the abnormality flag Fk in the third embodiment. The processes shown in FIG. 28 are carried out as a subroutine of S104 shown in FIG. 17 by the laser management controller 55.

Out of the processes shown in FIG. 28, the processes in S1046, S1047, and 51048 are the same as those in the second embodiment described with reference to FIG. 18. The second and third embodiments differ from each other in that the process in S1043 in FIG. 18 is replaced with the processes in S1041 and S1044 in FIG. 28.

In S1041, the laser management controller 55 calculates the thresholds for evaluation of abnormality of the laser performance parameters based on the number of in-chamber pulses Nchk in the numbered-k laser apparatus 30k. The following values are calculated as the thresholds for evaluation of abnormality of the laser performance parameters:

ΔVsmax(Nchk); (1)

ΔPLsmax(Nchk); (2)

ΔQsmax(Nchk); and (3)

Eσmax(Nchk). (4)

The process in S1041 will be described later in detail with reference to FIG. 29.

Thereafter, in S1044, the laser management controller 55 evaluates whether or not any of the laser performance parameters has exceeded a range determined in advance. For example, the laser management controller 55 evaluates whether or not any of the laser performance parameters is greater than or equal to the corresponding threshold for abnormality evaluation. Specifically, the laser management controller 55 evaluates whether or not any of the following conditions is satisfied:

ΔVsk≥ΔVsmax(Nchk); (1)

ΔPLsk≥ΔPLsmax(Nchk); (2)

ΔQsk≥ΔQsmax(Nchk); and (3)

Eσk≥Eσmax(Nchk). (4)

In S1043 described with reference to FIG. 18, the fixed thresholds are used irrespective of the number of in-chamber pulses Nchk, whereas in the process in S1044, thresholds according to the number of in-chamber pulses Nchk are used. The process in S1044 is the same as the process in S1043 except the thresholds for abnormality evaluation.

4.2.1.1 Calculation of Thresholds for Evaluation of Abnormality of Laser Performance Parameters

FIG. 29 is a flowchart in accordance with which the laser management controller 55 calculates a threshold for abnormality evaluation in the third embodiment. The processes shown in FIG. 29 are carried out as a subroutine of S1041 shown in FIG. 28 by the laser management controller 55.

First, in S1041a, the laser management controller 55 reads the number of in-chamber pulses Nchk in the numbered-k laser apparatus 30k from the storage 57. The number of in-chamber pulses Nchk is the number of in-chamber pulses Nchk counted in S215 in FIG. 19 or the number of in-chamber pulses Nchk stored as the table data shown in FIG. 20A.

Thereafter, in S1041b, the laser management controller 55 reads a function that relates the number of in-chamber pulses to a threshold for evaluation of abnormality of a laser performance parameter from the storage 57. The function is stored in the storage 57 in advance on a laser performance parameter basis.

Thereafter, in S1041c, the laser management controller 55 uses the number of in-chamber pulses Nchk read in S1041a and the function read in S1041b to calculate the threshold for evaluation of abnormality of the laser performance parameter.

After S1041c, the laser management controller 55 terminates the processes in the present flowchart and returns to the processes shown in FIG. 28. The thresholds for abnormality evaluation calculated in S1041c are used in S1044 in FIG. 28.

The other points are the same as those in the second embodiment.

### 5. Case where Abnormality of Xenon Concentration is Evaluated Based on Burst Characteristic Value

5.1 Overview

FIG. 30 describes the concept of burst operation performed by each of the laser apparatuses in a fourth embodiment of the present disclosure. The horizontal axis of FIG. 30 represents the time, and the vertical axis of FIG. 30 represents the pulse energy Ek of the pulsed laser light. The laser apparatuses are each configured to operate in a “burst period” in which the laser apparatus outputs the pulsed laser light at a predetermined repetitive frequency and a “pause period” in which the laser apparatus stops outputting the pulsed laser light at the predetermined repetitive frequency with the two periods alternately repeated. The operation described above is called burst operation. The burst period corresponds to a period for which a semiconductor wafer is exposed to light. The pause period corresponds to a period for which the semiconductor wafer is replaced with another in the exposure apparatus 100 or a period for which the pulsed laser light radiation position is moved from a chip region to another. To keep the pulse energy Ek substantially fixed for one burst period, the charge voltage Vk is controlled by using the processes shown in FIG. 19.

FIG. 31 describes a burst characteristic value analyzed in the fourth embodiment of the present disclosure. The horizontal axis of FIG. 31 represents the time, and the vertical axis of FIG. 31 represents the charge voltage Vk. Since the horizontal axis of FIG. 31 is expanded by a greater degree than the horizontal axis of FIG. 30, one burst period shown in FIG. 31 is widened. To keep the pulse energy Ek substantially fixed, the charge voltage Vk varies in one burst period in some cases. In an ArF excimer laser apparatus, to suppress the variation in the charge voltage Vk in one burst period, a laser gas containing a small amount of xenon gas is used. For example, the charge voltage Vk for keeping the pulse energy Ek substantially fixed for one burst period can be stabilized by setting the concentration of the xenon gas contained in the laser gas at 10 ppm.

However, for example, a decrease in the concentration of the xenon gas due to abnormality of the gas regeneration apparatus 50 increases in some cases the variation in the charge voltage Vk for keeping the pulse energy Ek substantially fixed for one burst period. The variation in the charge voltage Vk increases in the case where the concentration of the xenon gas is 5 ppm as compared with the variation in the case where the concentration of the xenon gas is 10 ppm. The variation in the charge voltage Vk further increases in the case where the concentration of the xenon gas is 0 ppm as compared with the variation in the case where the concentration of the xenon gas is 5 ppm. Based on the fact described above, a burst characteristic value ΔVBk, which is calculated by using the expression below, can be used to detect abnormality of the concentration of the xenon gas.

ΔVBk=VBen−VBst

where VBst represents the charge voltage at the start of a burst period, and VBen represents the charge voltage at the end of the burst period.

The configurations of the laser gas management system and the laser apparatuses in the fourth embodiment are the same as those in the second embodiment described with reference to FIG. 16.

5.2 Operation

The process in which the laser management controller 55 evaluates abnormality of the gas regeneration apparatus 50 in the fourth embodiment is the same as the process in the first embodiment described with reference to FIG. 8.

The process in which the laser management controller 55 counts the number of laser apparatuses in which abnormality of a laser performance parameter has been detected in the fourth embodiment is the same as process in the second embodiment described with reference to FIG. 17.

5.2.1 Process of Setting Abnormality Flag Fk

FIG. 32 is a flowchart in accordance with which the laser management controller 55 sets the abnormality flag Fk in the fourth embodiment. The processes shown in FIG. 32 are carried out as a subroutine of S104 shown in FIG. 17 by the laser management controller 55.

Out of the processes shown in FIG. 32, the processes in S1046, S1047, and 51048 are the same as those in the third embodiment described with reference to FIG. 28. The third and fourth embodiments differ from each other in that the processes in S1041 and S1044 in FIG. 28 are replaced with the processes in S1042 and S1045 in FIG. 32.

In S1042, the laser management controller 55 calculates the thresholds for evaluation of abnormality of the laser performance parameters based on the number of in-chamber pulses Nchk in the numbered-k laser apparatus 30k. The process in S1042 is the same as the process in S1041 shown in FIGS. 28 and 29 except that a threshold ΔVBmax(Nchk) of the burst characteristic value ΔVBk is added as a threshold for evaluation of abnormality of a laser performance parameter to be calculated.

Thereafter, in S1045, the laser management controller 55 evaluates whether or not any of the laser performance parameters has exceeded the range determined in advance. For example, the laser management controller 55 evaluates whether or not any of the laser performance parameters is greater than or equal to the corresponding threshold for abnormality evaluation. The process in S1045 is the same as the process in S1044 shown in FIG. 28 except that the following condition is added:

ΔVBk≥ΔVBmax(Nchk) (5)

5.2.2 Processes Carried Out by Laser Controller

The aforementioned burst characteristic value ΔVBk used to set the abnormality flag will next be described. The burst characteristic value ΔVBk is calculated by the laser management controller 55 that carries out the processes that will be described later with reference to FIGS. 34 and 35. The burst characteristic value ΔVBk is calculated based on the gas-control-related data that change with time as the control of each of the laser apparatuses progresses. Processes carried out by the laser controller 31 to generate the gas-control-related data will therefore be described with reference to FIG. 33 before the process of calculating the burst characteristic value ΔVBk is described.

FIG. 33 is a flowchart of energy control performed by the laser controller 31 of each of the laser apparatuses in the fourth embodiment. Out of the processes shown in FIG. 33, the processes in S210 to S212, S215 to S217, and 5220 to S222 are the same as those in the second embodiment described with reference to FIG. 19. The second and fourth embodiments differ from each other in that the process in S213 is carried out between S212 and S215 and the process in S218 in FIG. 19 is replaced with the process in S219 in FIG. 33.

In S213, the laser controller 31 measures a trigger interval Ts. The trigger interval Ts may be the interval between the light emission trigger signals received from the exposure apparatus controller 110 by the laser controller 31 or the interval between the light emission triggers transmitted by the laser controller 31 to the switch 13a. In place of the trigger interval Ts, the pulse interval may be measured based on the measured data received by the laser controller 31 from the power monitor 17. The trigger interval Ts or the pulse interval is measured with a time measurement apparatus that is not shown but is provided in the laser controller 31.

In S219, the laser controller 31 transmits the gas-control-related data to the laser management controller 55. The process in S219 is the same as the process in S218 in FIG. 19 except that the trigger interval Ts is added as the gas-control-related data transmitted to the laser management controller 55.

5.2.3 Calculation of Laser Performance Parameters

FIG. 34 is a flowchart in accordance with which the laser management controller 55 calculates the laser performance parameters in the fourth embodiment. Out of the processes shown in FIG. 34, the processes in S1900 to S1906 and S1908 to S1910 are the same as those in the second embodiment described with reference to FIG. 21. The second and fourth embodiments differ from each other in that the process in S1907 is carried out between S1906 and S1908.

In S1907, the laser management controller 55 calculates the following laser performance parameter of the numbered-k laser apparatus 30k based on the gas-control-related data between the points of time Time (a) and Time (b).

(5) Burst characteristic value ΔVBk

The process in S1907 will be described later in detail with reference to FIG. 35.

FIG. 35 is a flowchart showing the details of the process of calculating the burst characteristic value shown in FIG. 34. The processes shown in FIG. 35 are carried out as a subroutine of S1907 shown in FIG. 34 by the laser management controller 55.

First, in S1907a, the laser management controller 55 reads time-series data on the charge voltage Vk and the trigger interval Ts between the points of time Time(a) and Time(b).

Thereafter, in S1907b, the laser management controller 55 identifies the pulse at the start of a burst period and the pulse at the end of the burst period based on the time-series data on the trigger interval Ts. For example, provided that a trigger interval Ts longer than a predetermined value corresponds to the pause period, the pulse immediately after a first pause period is the pulse at the start of a burst period, and the pulse immediately before a second pause period that is the first period that appears after the first pause period is the pulse at the end of the burst period. The predetermined value is set, for example, at 0.2 seconds.

After the identification of the pulse at the start of a burst period and the pulse at the end of the burst period, the laser management controller 55 identifies charge voltage VBst at the start of the burst period and charge voltage VBen at the end of the burst period based on the time-series data on the charge voltage Vk. The charge voltage Vk at one pulse at the start of the burst period may be the charge voltage VBst, and the charge voltage Vk at one pulse at the end of the burst period may be the charge voltage VBen. Instead, the average of the charge voltages Vk at a plurality of pulses at the start of the burst period may be the charge voltage VBst, and the average of the charge voltages Vk at a plurality of pulses at the end of the burst period may be the charge voltage VBen.

Thereafter, in S1907c, the laser management controller 55 calculates the burst characteristic value ΔVBk of the numbered-k laser apparatus 30k by using the following expression:

ΔVBk=VBen−VBst

Instead, when a plurality of burst periods are present between the points of time Time (a) and Time (b), the burst characteristic values calculated for the plurality of burst periods may be averaged.

After S1907c, the laser management controller 55 terminates the processes in the present flowchart and returns to the processes shown in FIG. 34.

The burst characteristic value ΔVBk calculated by carrying out the processes in FIGS. 34 and 35 is used to set the abnormality flag Fk in FIG. 32.

5.2.4 Evaluation of Abnormality of Gas Regeneration Apparatus Based on Laser Performance Parameters

FIG. 36 is a table showing an example of the evaluation of abnormality of the gas regeneration apparatus 50 based on the laser performance parameters in the fourth embodiment. FIG. 36 differs from the example shown in FIG. 26 in that the burst characteristic value ΔVBk is added as a laser performance parameter.

In S1045 in FIG. 32, it is evaluated whether or not the laser performance parameters are each greater than or equal to the corresponding threshold for abnormality evaluation. A laser performance parameter determined to be greater than or equal to the corresponding threshold for abnormality evaluation is hatched in FIG. 36.

For example, at the point of time Time(a)+2Δt, the burst characteristic value ΔVB2[2] of the numbered−2 laser apparatus 302 and the burst characteristic value ΔVBn[2] of the numbered-n laser apparatus 30n are each determined to be greater than or equal to the corresponding threshold for abnormality evaluation. The abnormality flag Fk of each of the numbered−2 laser apparatus 302 and the numbered-n laser apparatus 30n at the point of time Time(a)+2Δt is 1 based on the processes shown in FIG. 32. When the abnormality flag Fk is 1 in two laser apparatuses, F=2 is provided based on the processes shown in FIG. 17. That is, it is determined that abnormality has occurred in the gas regeneration apparatus 50 based on the processes shown in FIG. 8. The term “OK” shown in the field “Evaluation” in FIG. 36 represents that no abnormality has occurred in the gas regeneration apparatus 50. The term “NG” shown in the field “Evaluation” in FIG. 36 represents that abnormality has occurred in the gas regeneration apparatus 50.

Further, in the fourth embodiment, when it is determined that the burst characteristic value ΔVBk is greater than or equal to the corresponding threshold for abnormality evaluation in two or more laser apparatuses, the laser management controller 55 determines that abnormality has occurred in the xenon gas processing in the gas regeneration apparatus 50. The laser management controller 55 outputs the fact that abnormality has occurred in the xenon gas processing in the gas regeneration apparatus 50 to the external apparatuses.

On the other hand, at the point of time Time(a)+5Δt, the amount of change in charge voltage ΔVs2[5] of the numbered−2 laser apparatus 302 per predetermined number of pulses ΔN and the burst characteristic value ΔVBn[5] of the numbered-n laser apparatus 30n are each determined to be greater than or equal to the corresponding threshold for abnormality evaluation. The abnormality flag Fk of each of the numbered−2 laser apparatus 302 and the numbered-n laser apparatus 30n at the point of time Time(a)+5Δt is 1 based on the processes shown in FIG. 32. When the abnormality flag Fk is 1 in two laser apparatuses, F=2 is provided based on the processes shown in FIG. 17. That is, it is determined that abnormality has occurred in the gas regeneration apparatus 50 based on the processes shown in FIG. 8.

It is, however, noted that even when F=2 is provided but when only one laser apparatus is determined to have a burst characteristic value ΔVBk greater than or equal to the corresponding threshold for abnormality evaluation, the laser management controller 55 may not determine that abnormality has occurred in the xenon gas processing in the gas regeneration apparatus 50.

The other points may be the same as those in the second or third embodiment.

### 6. Case where Regenerated Gas and New Gas are Switchable from One to the Other on a Laser Basis

6.1 Configuration

FIG. 37 schematically shows the configurations of a laser gas management system according to a fifth embodiment of the present disclosure and laser apparatuses 301 to 30n connected thereto. In the fifth embodiment, a new gas dedicated pipe 38, which is connected to the pipe 26, is provided as well as the pipe 27 connected both to the pipes 25 and 26. The new gas dedicated pipe 38 is connected to the pipe 26 between the regulator 86 and the valve B-V2.

The new gas dedicated pipe 38 branches into a plurality of pipes 381 to 38n corresponding to the plurality of laser apparatuses 301 to 30n. A valve B-V3 is disposed in each of the pipes 381 to 38n. The pipes 381 to 38n are connected to pipes 271 to 27n, respectively. Valves C-V5 are disposed in the pipes 271 to 27n on the upstream of the positions where the pipes 381 to 38n are connected to the pipes 271 to 27n. The valves B-V1 are disposed in the pipes 271 to 27n on the downstream of the positions where the pipes 381 to 38n are connected to the pipes 271 to 27n.

The other points are the same as those in the second embodiment described with reference to FIG. 16.

6.2 Operation

The pipe 27 is configured to selectively supply the laser apparatuses 301 to 30n with the new gas or the regenerated gas under the control of the gas regeneration apparatus 50 performed on the valves B-V2 and C-V2. In contrast, the new gas dedicated pipe 38 is configured to supply the laser apparatuses 301 to 30n with the new gas irrespective of the control performed by the gas regeneration apparatus 50.

The valves B-V3 and C-V5 in each of the laser apparatuses are controlled by the laser management controller 55. The valves B-V3 and C-V5 may instead be controlled by the gas controller 47 of each of the laser apparatuses. When the valve B-V3 is closed and the valve C-V5 is open in a laser apparatus, the regenerated gas or the new gas selected by the gas regeneration apparatus 50 is supplied to the laser apparatus via the pipe 27. When the valve B-V3 is open and the valve C-V5 is closed in another laser apparatus, the new gas is suppliable to the laser apparatus via the new gas dedicated pipe 38 irrespective of the control performed by the gas regeneration apparatus 50.

For example, when abnormality is detected in only one laser apparatus as a result of the evaluation of the laser performance parameters of the plurality of laser apparatuses 301 to 30n, it is conceivable that the gas regeneration apparatus 50 does not have a problem but the laser apparatus in which abnormality has been detected has a problem. Even when the laser apparatus in which abnormality has been detected has a problem, it may be desired in some cases to keep using the laser apparatus until a regular maintenance date. In such cases, the valve B-V3 of the laser apparatus in which abnormality has been detected may be opened and the valve C-V5 thereof may be closed. The new gas is thus suppliable to the laser apparatus in which abnormality has been detected irrespective of the control performed by the gas regeneration apparatus 50, whereby a decrease in the performance of the laser apparatus can be suppressed.

6.2.1 Process of Evaluating Abnormality of Gas Regeneration Apparatus

FIG. 38 is a flowchart in accordance with which the laser management controller 55 evaluates abnormality of the gas regeneration apparatus 50 in the fifth embodiment. The laser management controller 55 carries out the following processes to evaluate abnormality of the gas regeneration apparatus 50.

Out of the processes shown in FIG. 38, the processes in S10 and S13 to S18 are the same as those in the first embodiment described with reference to FIG. 8. The first and fifth embodiments differ from each other in that the processes in S11 and S12 are carried out between S10 and S13.

In S11, the laser management controller 55 evaluates whether or not abnormality of a laser performance parameter has been detected in one laser apparatus. When the abnormality of the laser performance parameter has been detected in one laser apparatus (YES in S11), the laser management controller 55 determines that abnormality has occurred in the one laser apparatus and proceeds to the process in S12. When the abnormality of the laser performance parameter has been detected in more than one laser apparatus (NO in S11), the laser management controller 55 proceeds to the process in S13.

In S12, the laser management controller 55 carries out the process of causing the laser apparatus in which abnormality has been detected to stop operating. The process in S12 will be described later in detail with reference to FIG. 39.

After S12, the laser management controller 55 terminates the processes in the present flowchart.

6.2.1.1 Process of Causing Laser Apparatus in which Abnormality has been Detected to Stop Operating

FIG. 39 is a flowchart showing the details of a process shown in FIG. 38 that is the process causing the laser apparatus in which abnormality of a laser performance parameter has been detected to stop operating. The processes shown in FIG. 39 are carried out as a subroutine of S12 shown in FIG. 38 by the laser management controller 55. In the following description, the one laser apparatus in which abnormality has been detected has a number m.

First, in S120, the laser management controller 55 notifies the laser controller 31 of the numbered-m laser apparatus 30m in which abnormality has been detected of the abnormality of the laser performance.

Thereafter, in S121, the laser management controller 55 closes the valve C-V5 of the numbered-m laser apparatus 30m and opens the valve B-V3 thereof. As a result, when the gas regeneration apparatus 50 supplies the numbered-m laser apparatus 30m with the buffer gas, the new gas is supplied in place of the regenerated gas. The valve C-V5 corresponds to the first valve in the present disclosure, and the valve B-V3 corresponds to the third valve in the present disclosure.

Having been notified of the abnormality of the laser performance in S120, the laser controller 31 of the numbered-m laser apparatus 30m closes the valve C-V1 and opens the valve EX-V2 in S122. Therefore, the discharge gas discharged from the numbered-m laser apparatus 30m is not supplied to the gas regeneration apparatus 50 but is discharged out of the laser apparatus. When the discharge gas discharged from the numbered-m laser apparatus 30m in which abnormality has been detected is allowed to be regenerated, the process in S122 may not be carried out.

Thereafter, in S123, the laser management controller 55 notifies the external apparatuses of the abnormality of the laser performance of the numbered-m laser apparatus 30m. The external apparatuses include, for example, the display apparatus 58. The display apparatus 58 displays a state representing abnormality of the numbered-m laser apparatus 30m. The external apparatuses further include, for example, the factory management system 59.

Thereafter, in S124, the laser management controller 55 evaluates whether or not the laser management controller 55 has received from any of the external apparatuses a signal representing that the numbered-m laser apparatus 30m is allowed to stop operating. When the laser management controller 55 has not received the signal representing that the numbered-m laser apparatus 30m is allowed to stop operating (NO in S124), the laser management controller 55 waits until the laser management controller 55 receives the signal representing that the numbered-m laser apparatus 30m is allowed to stop operating. In this case, the numbered-m laser apparatus 30m achieves laser oscillation without accepting the regenerated gas from the gas regeneration apparatus 50 and supplying the gas regeneration apparatus 50 with the discharge gas. When the laser management controller 55 has received the signal representing that the numbered-m laser apparatus 30m is allowed to stop operating (YES in S124), the laser management controller 55 proceeds to the process in S125.

Thereafter, in S125, the laser management controller 55 causes the numbered-m laser apparatus 30m to stop laser oscillation.

After S125, the laser management controller 55 terminates the processes in the present flowchart and returns to the processes shown in FIG. 38.

### 7. Others

FIG. 40 schematically shows the configuration of the exposure apparatus 100 connected to the laser apparatus 30k. The laser apparatus 30k generates the laser light and outputs the laser light to the exposure apparatus 100, as described above.

In FIG. 40, the exposure apparatus 100 includes an illumination optical system 141 and a projection optical system 142. The illumination optical system 141 is configured to illuminate a reticle pattern on a reticle stage RT with the laser light incident from the laser apparatus 30k. The projection optical system 142 is configured to perform reduction projection on the laser light having passed through the reticle to cause the laser light to be focused on a workpiece that is not shown but is placed on a workpiece table WT. The workpiece is a light sensitive substrate on which a photoresist has been applied, such as a semiconductor wafer. The exposure apparatus 100 is configured to translate the reticle stage RT and the workpiece table WT in synchronization with each other to expose the workpiece with the laser light having reflected the reticle pattern. An electronic device can be manufactured by transferring a device pattern onto the semiconductor wafer in the exposure step described above.

In the embodiments described above, it is determined that abnormality has occurred in the gas regeneration apparatus 50 when abnormality of a laser performance parameter has been detected in two or more laser apparatuses, but not necessarily in the present disclosure. It may be determined that abnormality has occurred in the gas regeneration apparatus 50 when abnormality of a laser performance parameter has been detected in X or more laser apparatuses, where X represents an integer greater than or equal to two. When abnormality of a laser performance parameter has been detected in less than X laser apparatuses, it may be determined that no abnormality has occurred in the gas regeneration apparatus 50.

In the fifth embodiment, when abnormality of a laser performance parameter has been detected in one laser apparatuses, it is determined that abnormality has occurred in the laser apparatus, but not necessarily in the present disclosure. When abnormality of a laser performance parameter has been detected in less than X laser apparatuses, where X represents an integer greater than or equal to two, it may be determined that abnormality has occurred in the laser apparatuses.

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious for those skilled in the art that embodiments of the present disclosure would be appropriately combined.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of the any thereof and any other than A, B, and C.

What is claimed is:

1. A laser gas management system comprising:
a gas regeneration apparatus connected to a plurality of excimer laser apparatuses and configured to regenerate a laser gas discharged from the plurality of excimer laser apparatuses into a regenerated gas and supply the plurality of excimer laser apparatuses with the regenerated gas; and
a controller configured to evaluate whether or not at least one parameter of any of the plurality of excimer laser apparatuses has exceeded a range determined in advance and determine that abnormality has occurred in the gas regeneration apparatus when the at least one parameter has exceeded the range determined in advance in two or more of the excimer laser apparatuses.

2. The laser gas management system according to claim 1,
wherein the at least one parameter includes one of an amount of change in charge voltage, an amount of change in chamber gas pressure, an amount of gas consumption, pulse energy stability, and a burst characteristic value.

3. The laser gas management system according to claim 1,
wherein the plurality of excimer laser apparatuses each include at least one chamber, and
the range determined in advance is determined in accordance with the number of pulses in the chamber.

4. The laser gas management system according to claim 1,
further comprising a display apparatus configured to display, based on a result of the evaluation performed by the controller, a state in which abnormality has occurred in the gas regeneration apparatus.

5. The laser gas management system according to claim 1,
wherein the controller is configured to stop supplying the gas regeneration apparatus with the laser gas discharged from the plurality of excimer laser apparatuses when the controller determines that abnormality occurs in the gas regeneration apparatus.

6. The laser gas management system according to claim 5,
wherein the plurality of excimer laser apparatuses each include a fifth valve via which the laser gas discharged from the excimer laser apparatus is supplied to the gas regeneration apparatus and a sixth valve via which the laser gas discharged from the excimer laser apparatus is exhausted out of the laser apparatus, and
the controller is configured to close the fifth valve provided in each of the plurality of excimer laser apparatuses and open the sixth valve provided in each of the plurality of excimer laser apparatuses when the controller determines that abnormality occurs in the gas regeneration apparatus.

7. The laser gas management system according to claim 1,
wherein the controller is configured to cause the gas regeneration apparatus to stop supplying the plurality of excimer laser apparatuses with the regenerated gas when the controller determines that abnormality occurs in the gas regeneration apparatus.

8. The laser gas management system according to claim 7,
wherein the gas regeneration apparatus includes a second valve via which the regenerated gas is supplied to the plurality of excimer laser apparatuses and a fourth valve via which a laser gas from a component outside the plurality of excimer laser apparatuses is supplied to the plurality of excimer laser apparatuses, and
the controller is configured to close the second valve and open the fourth valve when the controller determines that abnormality occurs in the gas regeneration apparatus.

9. The laser gas management system according to claim 1,
wherein when the at least one parameter has exceeded the range determined in advance in one of the excimer laser apparatuses, the controller is configured to determine that abnormality has occurred in the one excimer laser apparatus in which the at least one parameter has exceeded the range determined in advance.

10. The laser gas management system according to claim 9,
further comprising a display apparatus configured to display, based on a result of the evaluation performed by the controller, a state in which abnormality has occurred in the one excimer laser apparatus.

11. The laser gas management system according to claim 9,
wherein the controller is configured to stop supplying the gas regeneration apparatus with the laser gas discharged from the one excimer laser apparatus when the controller determines that abnormality occurs in the one excimer laser apparatus.

12. The laser gas management system according to claim 9,
wherein the controller is configured to cause the gas regeneration apparatus to stop supplying the one excimer laser apparatus with the regenerated gas when the controller determines that abnormality occurs in the one excimer laser apparatus.

13. The laser gas management system according to claim 9,
wherein the plurality of excimer laser apparatuses each include a first valve via which the regenerated gas is supplied to the excimer laser apparatus, and
the gas regeneration apparatus includes a second valve via which the regenerated gas is supplied to the plurality of excimer laser apparatuses, and
the controller is configured to close the first valve provided in the one excimer laser apparatus when the controller determines that abnormality has occurred in the one excimer laser apparatus and close the second valve when the controller determines that abnormality has occurred in the gas regeneration apparatus.

14. The laser gas management system according to claim 9,
wherein the plurality of excimer laser apparatuses each include a third valve via which a laser gas from a component outside the plurality of excimer laser apparatuses is supplied to the excimer laser apparatus, and
the gas regeneration apparatus includes a fourth valve via which the laser gas from the component outside the plurality of excimer laser apparatuses is supplied to the plurality of excimer laser apparatuses, and
the controller is configured to open the third valve provided in the one excimer laser apparatus when the controller determines that abnormality has occurred in the one excimer laser apparatus and open the fourth valve when the controller determines that abnormality has occurred in the gas regeneration apparatus.

15. A laser gas management system comprising:
a gas regeneration apparatus connected to a plurality of excimer laser apparatuses and configured to regenerate a laser gas discharged from the plurality of excimer laser apparatuses into a regenerated gas and supply the plurality of excimer laser apparatuses with the regenerated gas; and
a controller configured to evaluate whether or not at least one parameter of any of the plurality of excimer laser apparatuses has exceeded a range determined in advance and determine that abnormality has occurred in the gas regeneration apparatus when the at least one parameter has exceeded the range determined in advance in a predetermined number of excimer laser apparatuses out of the excimer laser apparatuses, the predetermined number being at least two.

16. The laser gas management system according to claim 15,
wherein the controller is configured to determine that abnormality has occurred in the excimer laser apparatuses in which the at least one parameter has exceeded the range determined in advance when the at least one parameter has exceeded the range determined in advance in less than the predetermined number of excimer laser apparatuses out of the excimer laser apparatuses.

17. A method for manufacturing an electronic device, the method comprising:
causing an excimer laser apparatus in an excimer laser system to generate laser light, the excimer laser system including
a plurality of excimer laser apparatuses,
a gas regeneration apparatus connected to the plurality of excimer laser apparatuses and configured to regenerate a laser gas discharged from the plurality of excimer laser apparatuses into a regenerated gas and supply the plurality of excimer laser apparatuses with the regenerated gas, and
a controller configured to evaluate whether or not at least one parameter of any of the plurality of excimer laser apparatuses has exceeded a range determined in advance and determine that abnormality has occurred in the gas regeneration apparatus when the at least one parameter has exceeded the range determined in advance in a predetermined number of excimer laser apparatuses out of the excimer laser apparatuses, the predetermined number being at least two;
outputting the laser light to an exposure apparatus; and
exposing a light sensitive substrate with the laser light in the exposure apparatus to manufacture the electronic device.

18. The method for manufacturing an electronic device according to claim 17,
wherein when the at least one parameter has exceeded the range determined in advance in less than the predetermined number of excimer laser apparatuses out of the excimer laser apparatuses, the controller is configured to determine that abnormality has occurred in the excimer laser apparatuses in which the at least one parameter has exceeded the range determined in advance.

19. A method for controlling an excimer laser system including a plurality of excimer laser apparatuses and a gas regeneration apparatus configured to regenerate a laser gas discharged from the plurality of excimer laser apparatuses into a regenerated gas and supply the plurality of excimer laser apparatuses with the regenerated gas, the method comprising:
evaluating whether or not at least one parameter of any of the plurality of excimer laser apparatuses has exceeded a range determined in advance; and
determining that abnormality has occurred in the gas regeneration apparatus when the at least one parameter has exceeded the range determined in advance in a predetermined number of excimer laser apparatuses out of the excimer laser apparatuses, the predetermined number being at least two.

20. The method for controlling an excimer laser system according to claim 19, further comprising
determining that abnormality has occurred in the excimer laser apparatuses in which the at least one parameter has exceeded the range determined in advance when the at least one parameter has exceeded the range determined in advance in less than the predetermined number of excimer laser apparatuses out of the excimer laser apparatuses.
